(19) United States
(12) Patent Application Publication
(10) Pub. No.: US 2026/0329242 A1
(43) Pub. Date: Oct. 22, 2026

(54) BUILDING MANAGEMENT SYSTEM WITH RESOURCE CONSUMPTION MANAGEMENT FEATURES AND DASHBOARD

(71) Applicant: Tyco Fire & Security GmbH, Neuhausen am Rheinfall (CH)

(72) Inventors: Tushar Kshirsagar, Allentown, PA (US); Vineet Binodshanker Sinha, Brookfield, WI (US); Robbie G. Davis, Kew Gardens, NY (US); Tulshiram Waghmare, Pune (IN); Rajesh Nayak, Vidyaratna Nagar Manipal (IN)

(21) Appl. No.: 19/651,077

(22) Filed: Apr. 17, 2026

(30) Foreign Application Priority Data
Apr. 17, 2025 (IN) 202541037216

(51) Int. Cl. G05B 13/04

(52) U.S. Cl. CPC G05B 13/048

(57) ABSTRACT

One or more aspects relate to a method. The method includes detecting, by processing circuitry, a fault associated with a building device at a first time. The method includes generating a projected resource wastage trajectory comprising a plurality of projected wastage amounts. Each projected wastage amount corresponds to a different subperiod of a time period occurring after the first time and indicates an amount of resource wastage predicted to occur during the subperiod as a result of the fault. The method includes converting one or more of the projected wastage amounts occurring after a second time during the time period into one or more projected resource preservation amounts in response to identifying a corrective action to be taken at the second time to resolve the fault. The method includes initiating the corrective action at the second time to resolve the fault and realize the projected resource preservation amounts.

### CROSS-REFERENCE TO RELATED PATENT APPLICATION

This application claims priority to and the benefit of Indian Provisional Patent Application No. 202541037216, filed Apr. 17, 2025, the entirety of which is incorporated by reference herein.

### BACKGROUND

The present disclosure relates generally to a building system of a building. The present disclosure relates more particularly to systems for managing and controlling resource consumption of building devices (e.g., electricity, natural gas, water, etc.).

### SUMMARY

One or more aspects relate to a method. The method includes detecting, by processing circuitry, a fault associated with a building device occurring at a first time. The method includes generating, by the processing circuitry, a projected resource wastage trajectory comprising a plurality of projected resource wastage amounts. Each projected resource wastage amount may correspond to a different subperiod of a time period occurring after the first time and indicates an amount of resource wastage predicted to occur during the subperiod as a result of the building device operating with the fault. The method includes converting, by the processing circuitry, one or more of the plurality of projected resource wastage amounts occurring after a second time during the time period into one or more projected resource preservation amounts in response to identifying a corrective action to be taken at the second time to resolve the fault. The method includes initiating the corrective action at the second time to resolve the fault and realize the one or more projected resource preservation amounts.

In some implementations, the method includes determining, by the processing circuitry, a realized resource preservation amount for the time period based on the one or more projected resource preservation amounts for the one or more subperiods occurring after the second time in response to determining that the corrective action was taken at the second time to resolve the fault. In some implementations, the method includes determining, by the processing circuitry, that the fault was resolved at the second time based on operating data characterizing operation of the building device after the second time. In some implementations, determining the resource wastage trajectory includes implementing, by the processing circuitry, one or more mathematical models based on at least one of a fault type, an equipment type, or a resource type. In some implementations, the one or more mathematical models are modeled based on historical resource consumption data for the building equipment stored in a database.

In some implementations, a resource represented by the resource wastage trajectory includes at least one of energy, greenhouse gas, regulatory compliance, asset life, maintenance needs, operational efficiency metrics, time savings, productivity metrics, or health parameters. In some implementations, the method includes generating, by the processing circuitry, a priority level for the fault based on the projected resource wastage trajectory. In some implementations, the corrective action includes at least one of an equipment setpoint change, a work order creation, an equipment maintenance action, an equipment replacement, or an equipment update.

One or more aspects relate to a building management system. The building management system includes one or more processing circuits configured to detect a fault associated with a building device occurring at a first time. The one or more processing circuits may be configured to generate a projected resource wastage trajectory comprising a plurality of projected resource wastage amounts. Each projected resource wastage amount may correspond to a different subperiod of a time period occurring after the first time and indicate an amount of resource wastage predicted to occur during the subperiod as a result of the building device operating with the fault. The one or more processing circuits may be configured to convert one or more of the plurality of projected wastage amounts occurring after a second time during the time period into one or more projected resource preservation amounts in response to identifying a corrective action to be taken at the second time to resolve the fault. The one or more processing circuits may be configured to generate, for display on a graphical user interface (GUI), a first display. The first display may include a first plurality of widgets and a second plurality of widgets. The first plurality of widgets may include data characterizing a plurality of building devices. At least one widget of the first plurality of widgets may correspond to the building device associated with the fault. The second plurality of widgets may include at least one of the projected resource wastage trajectory or the plurality of projected resource wastage amounts, or the one or more projected resource preservation amounts.

In some implementations, the one or more processing circuits are further configured to generate, for display on the GUI, a recommendation to initiate the corrective action at the second time to resolve the fault and to realize the one or more projected resource preservation amounts. In some implementations, the one or more processing circuits are further configured to automatically initiate the corrective action at the second time responsive to receiving an input via the GUI. In some implementations, the one or more processing circuits are further configured to determine a realized resource preservation amount for the time period based on the one or more projected resource preservation amounts for the one or more subperiods occurring after the second time in response to determining that the corrective action was taken at the second time to resolve the fault.

In some implementations, the one or more processing circuits are further configured to determine that the fault was resolved at the second time based on operating data characterizing operation of the building device after the second time. In some implementations, determining the resource wastage trajectory includes implementing one or more mathematical models based on at least one of a fault type, an equipment type, or a resource type. In some implementations, the one or more mathematical models are modeled based on historical resource consumption data for the building equipment stored in a database. In some implementations, a resource represented by the resource wastage trajectory includes at least one of energy, greenhouse gas, regulatory compliance, asset life, maintenance needs, operational efficiency metrics, time savings, productivity metrics, or health parameters. In some implementations, the one or more processing circuits are further configured to generate a priority level for the fault based on the projected resource wastage trajectory. In some implementations, the corrective action includes at least one of an equipment setpoint change, a work order creation, an equipment maintenance action, an equipment replacement, or an equipment update.

One or more aspects relate to a non-transitory computer readable medium including one or more instructions stored thereon and executable by a processor to detect operation of a building device over a time period. The instructions are executable by the processor to determine an actual run time of the building device during the time period based on the detected operation. The instructions are executable by the processor to identify a subset of the actual run time as inefficient run time based on one or more operating conditions associated with the building device during the time period. The instructions are executable by the processor to determine a useful life wastage amount indicating an amount of asset life of the building device consumed as a result of the inefficient run time. The instructions are executable by the processor to determine, based on the one or more operating conditions, a cause of the inefficient run time and a corrective action responsive to the cause. The instructions are executable by the processor to initiate the corrective action to modify the operation of the building device.

In some implementations, the non-transitory computer readable medium further include one or more instructions executable by the processor to generate, for display on a graphical user interface (GUI), a display including a first plurality of widgets and a second plurality of widgets. The first plurality of widgets may include data characterizing a plurality of building devices, at least one widget of the first plurality of widgets may correspond to the building device associated with the inefficient run time. The second plurality of widgets may include at least one of the actual run time of the building device, the inefficient run time, or the useful life wastage amount.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a heating, ventilation, and/or air conditioning (HVAC) system, according to an exemplary embodiment.

FIG. 2 is a schematic diagram of a waterside system which can be used in conjunction with the building of FIG. 1, according to some embodiments.

FIG. 3 is a schematic diagram of an airside system which can be used in conjunction with the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a block diagram of a system to project resource wastage amounts for the building of FIG. 1, according to some embodiments.

FIG. 7 is a user interface displaying a plurality of widgets associated with resource consumption, according to some embodiments.

FIGS. 8A-8B is a user interface displaying a plurality of widgets associated with resource consumption, according to some embodiments.

FIG. 9 is a user interface displaying a plurality of widgets associated with resource consumption, according to some embodiments.

FIG. 10 is a user interface displaying a plurality of widgets associated with resource consumption, according to some embodiments.

FIG. 11 is a user interface displaying a plurality of widgets associated with resource consumption, according to some embodiments.

FIG. 12 is a user interface displaying a plurality of widgets associated with resource consumption, according to some embodiments.

FIG. 13 is a user interface displaying a plurality of widgets associated with resource consumption, according to some embodiments.

FIGS. 14A-14B are a user interface displaying a plurality of widgets associated with resource consumption, according to some embodiments.

FIG. 15 is a user interface displaying a plurality of widgets associated with resource consumption, according to some embodiments.

FIG. 16 is a user interface displaying a plurality of widgets associated with resource consumption, according to some embodiments.

FIG. 17 is a user interface displaying a plurality of widgets associated with resource consumption, according to some embodiments.

FIG. 18 is a user interface displaying a plurality of widgets associated with resource consumption, according to some embodiments.

FIG. 19 is a user interface displaying a plurality of widgets associated with resource consumption, according to some embodiments.

FIG. 20 is a user interface displaying a plurality of widgets associated with resource consumption, according to some embodiments.

FIG. 21 is a flow diagram of a method for monitoring resource wastage, according to some embodiments.

FIG. 22 is a flow diagram of a method for monitoring resource wastage, according to some embodiments.

FIG. 23 is a flow diagram of a method for monitoring resource wastage, according to some embodiments.

### DETAILED DESCRIPTION

Referring generally to the FIGURES, systems and methods are provided for a building resource consumption system configured to monitor resource consumption, generate projected resource wastage amounts, and generate resource conservation amounts. The systems and methods described herein can be used to actively monitor and control building equipment to conserve resources consumed when operating the building equipment (e.g., electricity, natural gas, water, etc.) and/or initiate corrective actions to mitigate resource wastage as a result of faults in the building equipment.

Pieces of building equipment or equipment devices may experience faults or other events that may result in inefficient performance. These faults may result in increased resource consumption. It can be difficult to determine the impact of a building fault on resource consumption.

Technically and beneficially, the systems and methods of some embodiments described herein provide an automated manner of detecting faults in building devices and automatically generate predicted resource wastage amounts due to the building devices operating with the fault, as well as predicted resource preservation amounts associated with resolving the faults. Generating the resource wastage and preservation amounts and providing them to a user via a user interface allows a user to view and understand the information in a more concise manner, in some embodiments. For example, the user may easily identify the negative impact that a building device operating with a fault may have, allowing them to act accordingly and minimize resource wastage. This improves equipment performance and can reduce inefficiencies and increased emissions or resource wastage. Further, the systems and methods described herein utilize a plurality of precise mathematical models to predict the impact on resource consumption for a given building device fault. This may streamline resource consumption tracking. For example, a fault need not be resolved in order for the potential impact to be identified. Further, faults that have a high potential impact on resource consumption may be identified and displayed on the user interface, indicating an importance of addressing those faults.

Further, the systems and methods described herein may provide faster servicing of critical faults. For example, the systems and methods herein may identify a corrective action associated with resolving the fault. When the corrective action is identified, the system described herein may automatically implement the action where possible. Otherwise, the system may display, on the user interface, the corrective action that should be taken to resolve the fault. This may reduce the amount of time that equipment operates with faults, and therefore reduces unnecessary resource consumption, among other technical improvements. These and other improvements and advantages are described in detail throughout the present disclosure.

### Building HVAC Systems and Building Management Systems

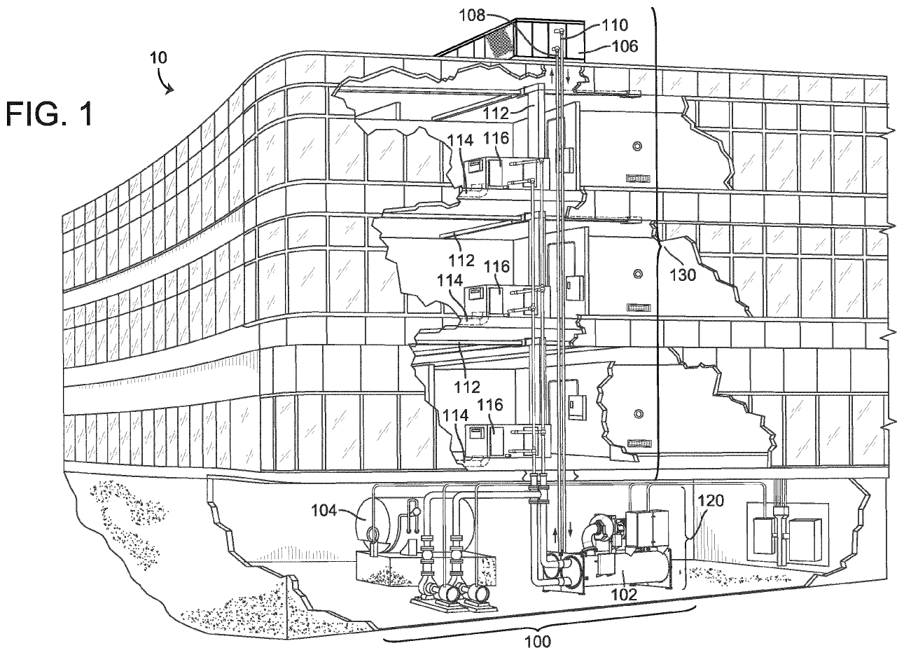

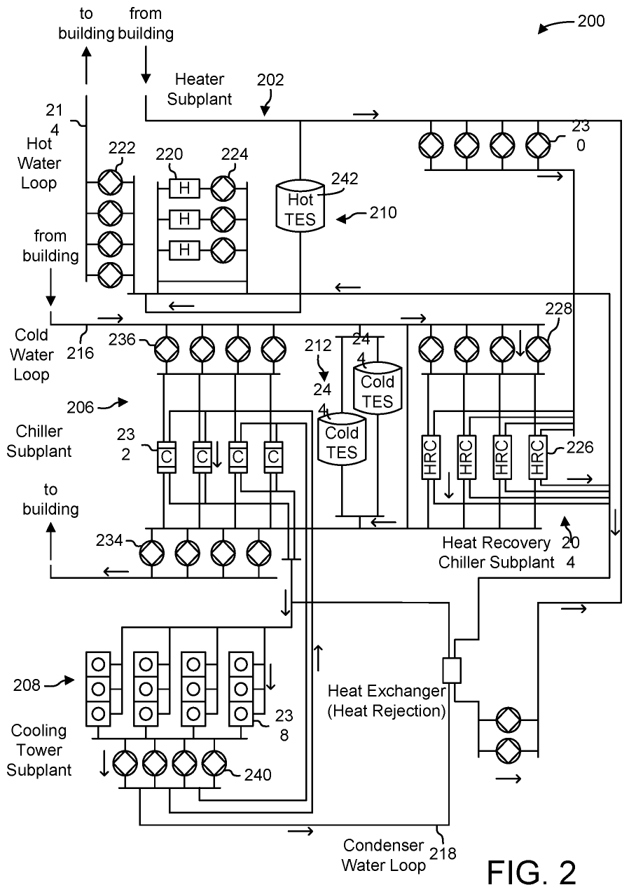

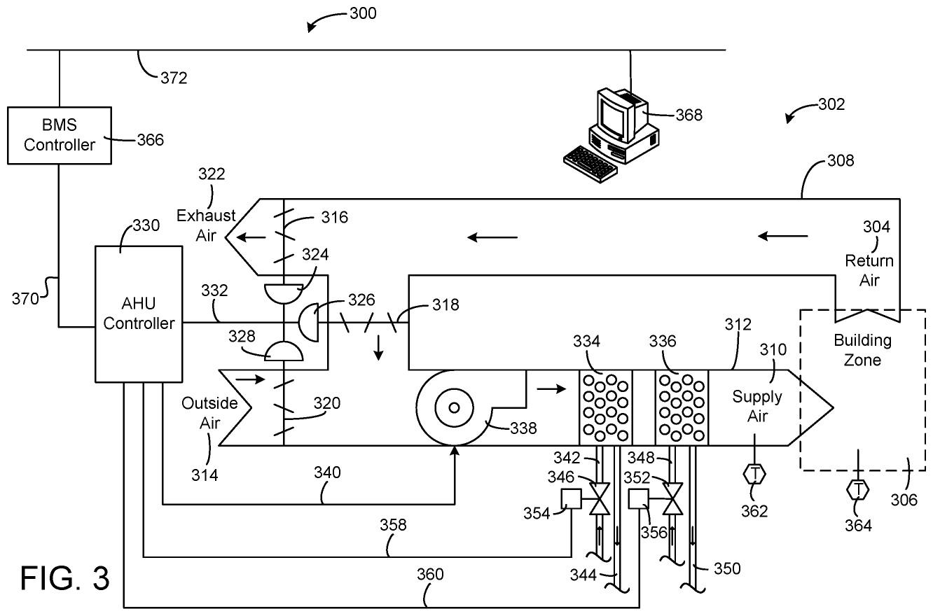

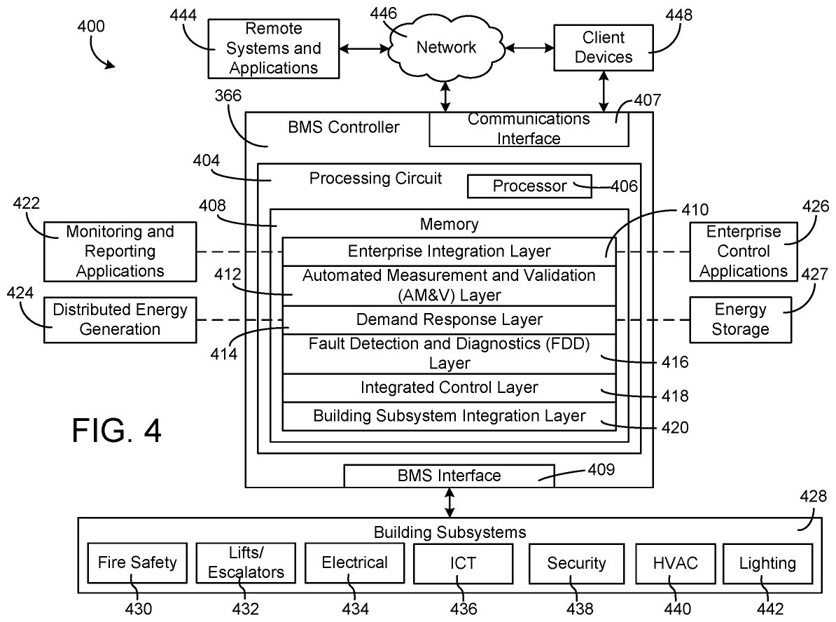

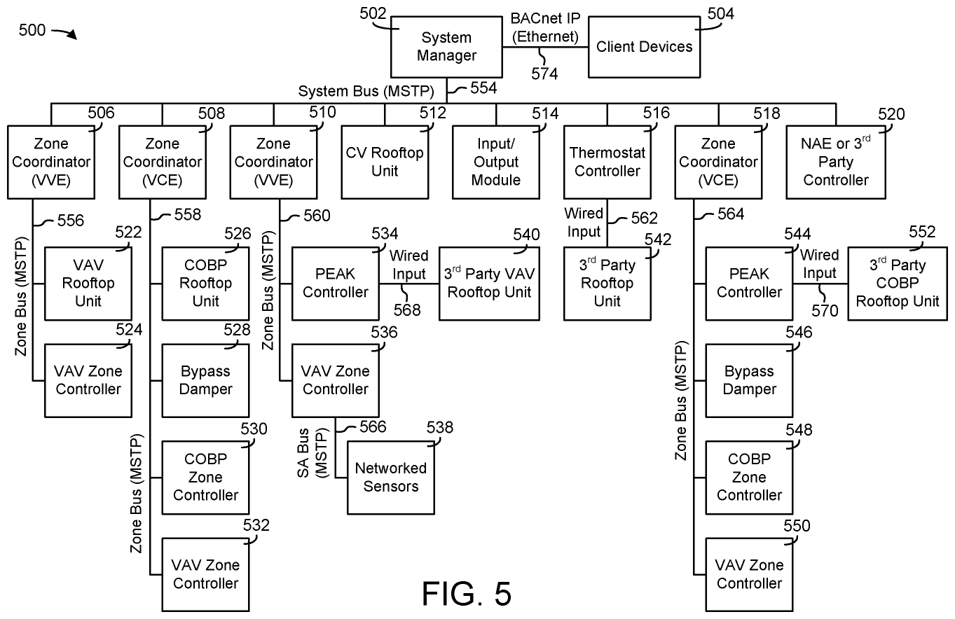

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building 10 and HVAC System 100

Referring particularly to FIG. 1, a perspective view of building 10 is shown. Building 10 is served by a BMS. A BMS is, in general, a system of equipment devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2 and 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System 200

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System 300

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management System 400

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, thermostats, and other devices for controlling the temperature, humidity, airflow, or other variable conditions within building 10. Lighting subsystem 442 can include any number of light fixtures, ballasts, lighting sensors, dimmers, and/or other devices configured to controllably adjust the amount of light provided to a building space. Security subsystem 438 can include occupancy sensors, video surveillance cameras, digital video recorders, video processing servers, intrusion detection devices, access control devices and servers, and/or other security-related devices.

Still referring to FIG. 4, BMS controller 366 is shown to include a communications interface 407 and a BMS interface 409. Communications interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Communications interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Communications interfaces 407 and/or BMS interface 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via communications interfaces 407 and/or BMS interface 409 can be direct (e.g., local wired or wireless communications) or via a communications network 446 (e.g., a WAN, the Internet, a cellular network, etc.). For example, communications interfaces 407 and/or BMS interface 409 can include an Ethernet card and port for sending and receiving data via an Ethernet-based communications link or network. In another example, communications interfaces 407 and/or BMS interface 409 can include a Wi-Fi transceiver for communicating via a wireless communications network. In another example, one or both of communications interfaces 407 and BMS interface 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via communications interfaces 407 and/or BMS interface 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at communications interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs (e.g., internal to building 10, external to building 10, etc.) such as temperature, carbon dioxide levels, relative humidity levels, air quality sensor outputs, occupancy sensor outputs, room schedules, weather conditions, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints, etc.) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface, etc.) so that the control actions initiated in response to demand inputs can be tailored for the user's application, desired comfort level, particular building equipment, and/or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and/or when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, and/or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage, etc.) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint.

These processes can be examined by FDD layer 416 to expose when the system begins to degrade in performance and alert a user to repair the fault before it becomes more severe.

Several examples of FDD models and processes that can be used by the system 400 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The system 400 can use these or other FDD models or processes to help diagnose the root causes of problems associated with the building equipment and identify the particular actions that can be taken by the system 400 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

In some embodiments, the system 400 may have associated warranty data. In some embodiments, the warranty data include reliability data that indicate the failure rates, expected time until failure, or other reliability metrics of various types of building equipment (e.g., particular equipment models) or components thereof. The reliability data can be generated from a set of service actions performed by a manufacturer or service provider and/or warranty claims submitted by various customers across a large set of building equipment over time. In some embodiments, the warranty data include freeform text included in warranty claims, photographs or videos of failed equipment, service reports generated when performing service on equipment under warranty, or any other type of data associated with equipment under warranty. These and other examples of warranty data are described in greater detail in U.S. patent application Ser. No. 17/971,342 filed Oct. 21, 2022, U.S. patent application Ser. No. 18/116,974 filed Mar. 3, 2023, U.S. patent application Ser. No. 17/530,257 filed Nov. 18, 2021, and Singapore patent application Ser. No. 10202250321D filed Jun. 28, 2022, the entire disclosures of which are incorporated by reference herein. The warranty data can include structured and/or unstructured data of any type or format.

### Building Management System 500

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Resource Consumption Monitoring and Dashboard

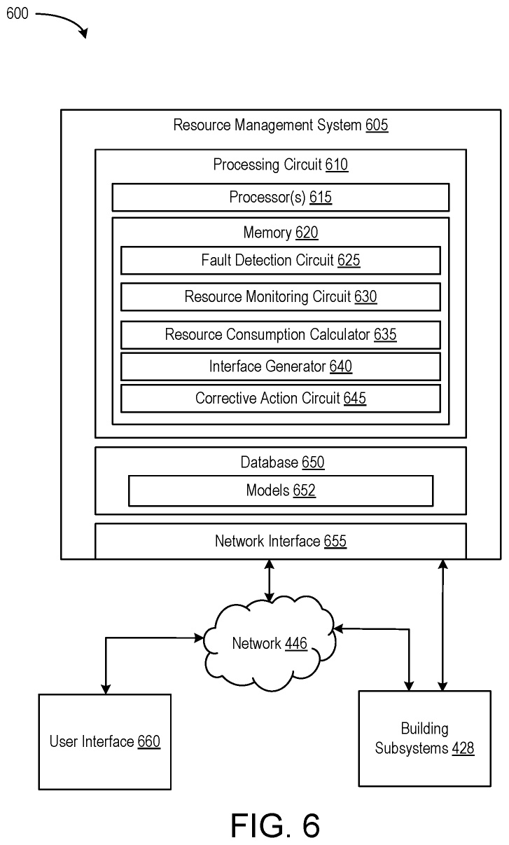

Referring now to FIG. 6, a block diagram for a system 600 is shown, according to some embodiments. It should be noted that the number and type of components shown is merely illustrative and, in various implementations, implementations of the system 600 may have additional, fewer, and/or different components than those illustrated in FIG. 6 including those mentioned elsewhere herein. The system 600 may include at least one resource management system 605 and a user interface 660. The components of the system 600 may be connected, in wired or wireless connection, via the network 446. In some implementations, the system 600 is connected to the building subsystems 428 via the network 446.

Generally, the resource management system 605 may include one or more logic devices, which may be one or more computing devices equipped with one or more processing circuits (e.g., processing circuitry) that run instructions stored in a memory device to perform various operations. For example, the resource management system 605 includes processing circuit 610 that runs the instructions stored in memory 620. The processing circuit 610 may be made up of various components such as a microprocessor, an ASIC, or an FPGA, and the memory device may be any type of storage or transmission device capable of providing program instructions. The resource management system 605 may include one or more processor(s) 615. The memory 620 may store programming logic (e.g., computer or machine-readable instructions) that, when executed by one or more processors, controls the operation of the corresponding system or device (e.g., causes the one or more processors to perform operations). For example, the processor(s) 615 execute the programming logic stored in the memory 620. The memory 620 may also store data in databases, such as database 650.

The resource management system 605 may include a communication interface or network interface. For example, the processing circuit 610 may be communicably coupled to a network interface 655. The network interface 655 may allow the systems and devices in the system 600 to communicate wirelessly or otherwise. The network interfaces can be direct (e.g., local wired or wireless communications) and/or via a communications network (e.g., the network 446). For example, the network interface 655 may include Ethernet cards and ports for sending and receiving data via an Ethernet-based communications link or network. The network interface 655 may also include Wi-Fi transceivers for communicating via the network 446. The network interface 655 can include power line communications interfaces. The network interface 655 can include Ethernet interfaces, USB interfaces, serial communications interfaces, and/or parallel communications interfaces.

The memory 620 is shown as including several components, including fault detection circuit 625, resource monitoring circuit 630, resource consumption calculator 635, interface generator 640, and corrective action circuit 645. In some examples, these components may be implemented as instructions stored within the memory 620 or one or more other computer-readable storage media that are executable by the processor(s) 615 to perform various functions described herein. In some implementations, the components may additionally or alternatively be implemented in part or in whole using hardware. All such alternatives are contemplated within the scope of the present disclosure.

The fault detection circuit 625 may be configured to process a wide variety of operating data from the building subsystems 428 to identify abnormal operating conditions. For example, the fault detection circuit 625 may process sensor data, setpoints, control signals, alarm data, status data, and measured performance data for various building assets to detect various fault conditions. Additionally or alternatively, the fault detection circuit 625 may communicate with the FDD layer 416 to detect faults. As described herein, the fault conditions may refer to operating states, control states, or performance conditions indicative of abnormal, inefficient, or degraded operation of a building asset, such as simultaneous heating and cooling, short cycling, sensor failure, actuator failure, a deviation between a commanded state and actual state, failure to satisfy a setpoint, and so on. Additionally or alternatively, the fault detection circuit 625 may be configured to detect operation of an asset outside of a scheduled time period.

The resource monitoring circuit 630 may be configured to process a wide variety of operating data from the building subsystems 428 to monitor events associated with resource consumption. For example, the resource monitoring circuit 630 may monitor operation of an AHU to determine that the AHU is consuming an excessive amount of energy relative to a baseline or expected operating condition. Additionally or alternatively, the resource monitoring circuit 630 may monitor a thermostat to determine that heating, cooling, or ventilation is being provided during an unoccupied period, outside of a scheduled period, or when such operation is otherwise unnecessary.

The resource consumption calculator 635 may be configured to determine projected resource consumption amounts for assets operating in the building subsystems 428. Additionally or alternatively, the resource consumption calculator 625 may determine projected resource wastage amounts associated with building assets operating with a detected fault condition. For example, in response to detecting that an asset is operating with a fault condition, the resource consumption calculator 635 may determine an amount of additional resources (e.g., energy, water, gas, greenhouse gas emissions, asset run time, etc.) projected to occur over a future time period if the fault condition remains uncorrected.

In some embodiments, the resource consumption calculator 635 may implement various mathematical models, shown as models 652, to determine a projected resource wastage trajectory. For example, the models 652 may be stored in the memory 620 or the database 650. In some embodiments, the models 652 may be stored remotely and are therefore retrieved from the network interface 655. The resource consumption calculator 635 may utilize the various models 652 to generate a projected resource wastage trajectory for an asset associated with an identified fault. The resource consumption calculator 635 may implement one or more selected models 652 based on a category associated with the fault. For example, the category may be at least one of a fault type, an equipment type, or a resource type.

The corrective action circuit 645 may be configured to control operation of various components of the building subsystems 428 based on detected fault conditions. For example, the corrective action circuit 645 may modify a setpoint, change a schedule, disable or enable operation of a building asset, cause a device to enter an occupied or unoccupied mode, reset a control parameter, shut down an unnecessarily operating device, or generate and transmit a work order, maintenance recommendation, or other service notification to resolve the detected fault condition and reduce associated resource wastage.

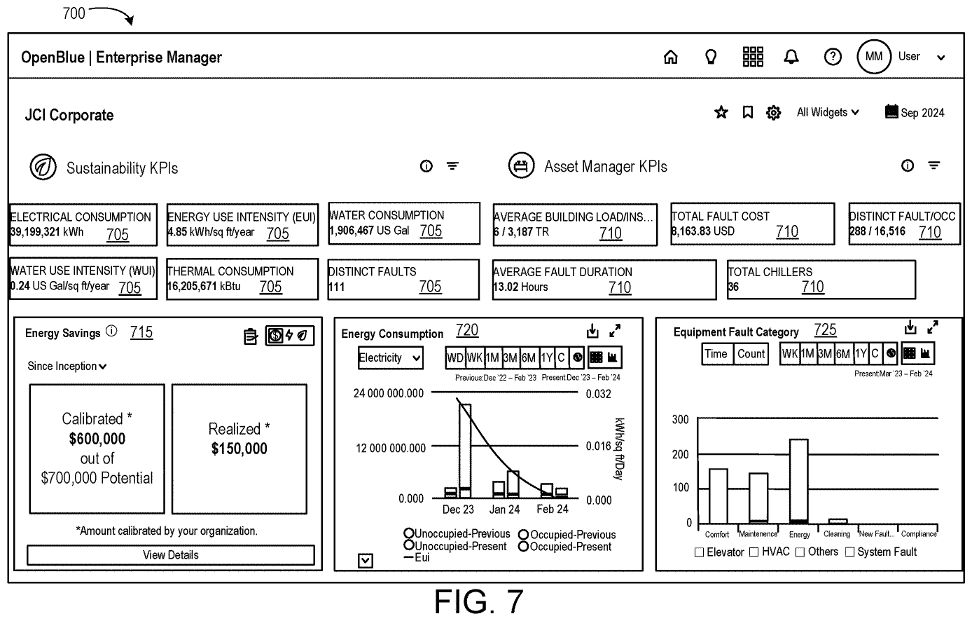

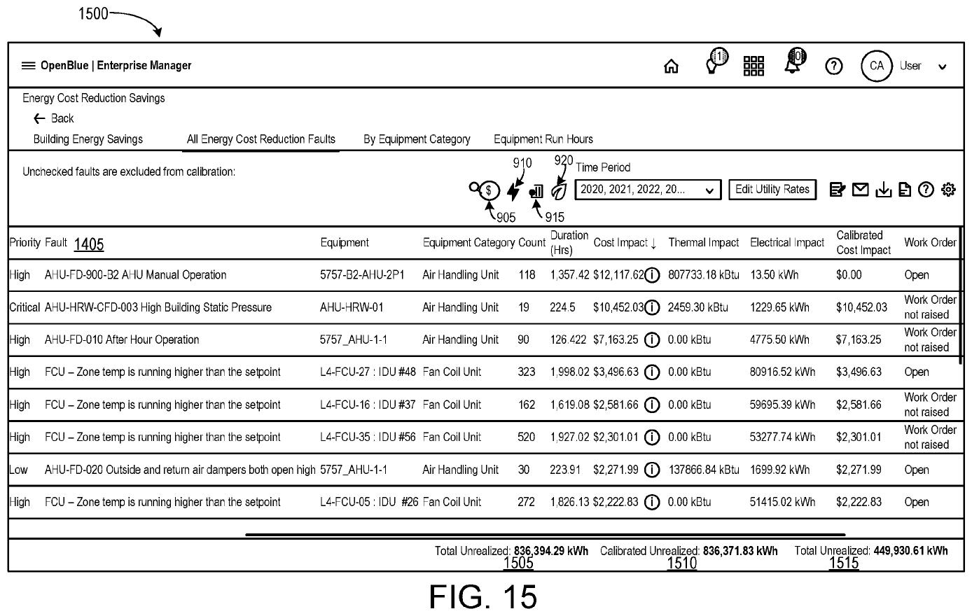

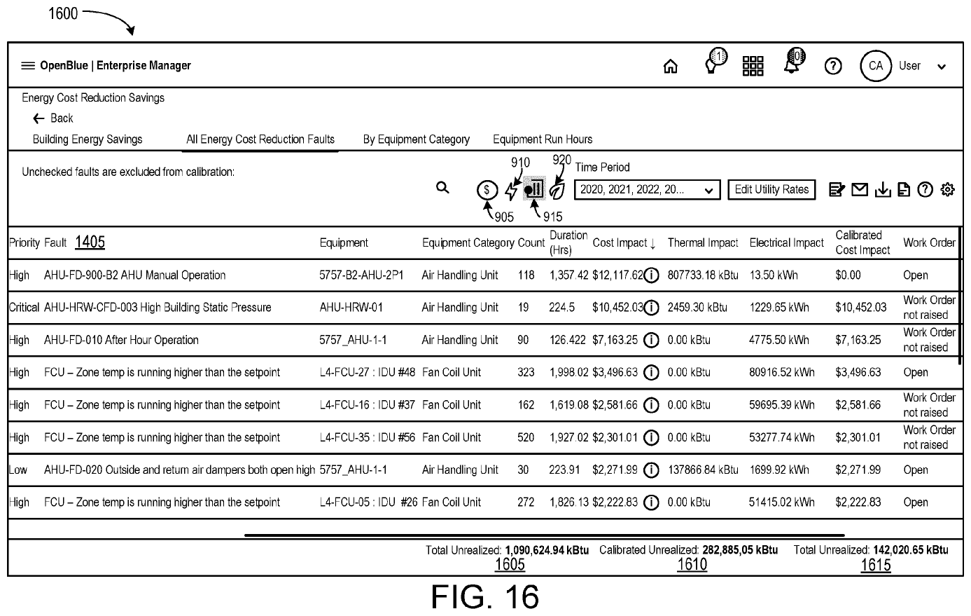

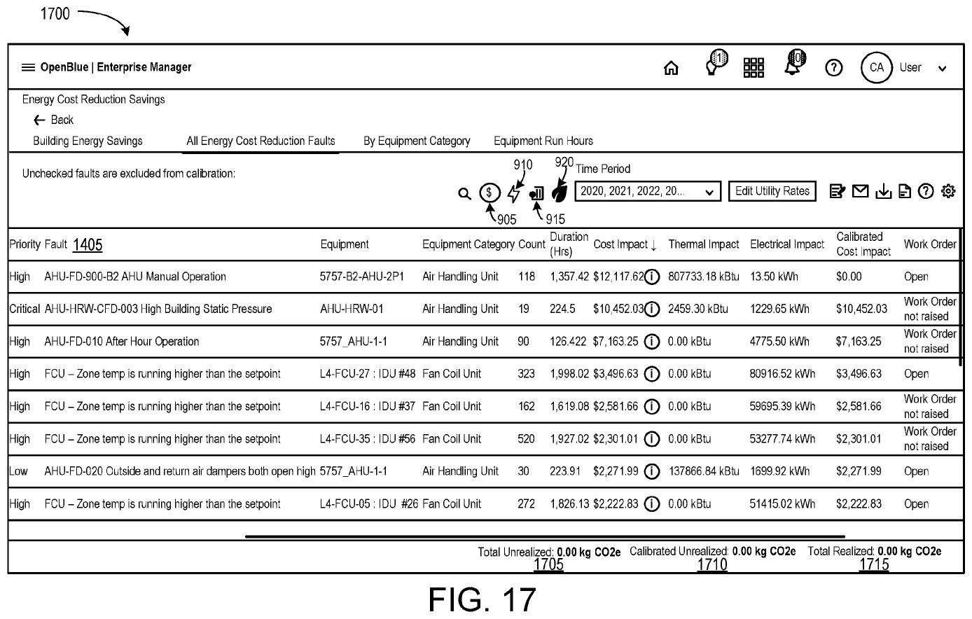

The user interface 660 may be a display on a user device, such as the client device 368. The interface generator 640 may generate the graphical user interfaces (GUIs) described further herein to display on the user interface 660. For example, the user interfaces 700-2000, described further herein with respect to FIGS. 7-20, may be displayed on the user interface 660.

The models 652 may model or represent resource consumption patterns for the various assets or equipment of the building subsystems 428. In some embodiments, the resource management system 605 may model or generate the models 652 based on historical resource consumption data for the building equipment of the building subsystems 428. For example, the historical resource consumption data may be stored in the database 650. In some embodiments, the historical data may be located elsewhere, such as a remote storage location accessible by the network interface 655. In some embodiments, the models 652 may be parametric models or deterministic models. Additionally or alternatively, one or more machine-learning (ML) models may be implemented (e.g., by themselves or along with the mathematical models).

In some embodiments, the models 652 include one or more energy and sustainability models for the various assets of the building subsystems 428. For example, one of the models 652 may be an energy reduction model, which the resource consumption calculator 635 may implement to calculate or determine an energy preservation amount that may be realized in response to implementing a corrective action, an optimized building control, or otherwise modifying operation of a building asset. The energy reduction model may compare a baseline energy usage (e.g., kWh, etc.) for the building asset before implementation of the modification to a post-implementation energy usage to calculate a difference in energy consumption. Additionally or alternatively, one of the models may be a greenhouse gas reduction model, which the resource consumption calculator 635 may implement to calculate or determine a greenhouse gas consumption reduction that may be realized in response to implementation of the modification. The greenhouse gas reduction model may compare CO2e emissions before and after implementation of the modification using energy consumption data (e.g., received from the building subsystems 428, etc.) and emission factors. Additionally or alternatively, one of the models 652 may be a regulatory compliance model, which the resource consumption calculator 635 may implement to determine or predict whether the modification to the building subsystems 428 satisfies one or more compliance criteria or other rules associated with energy consumption. For example, the regulatory compliance model may identify an expected penalty associated with noncompliant operation of the building subsystems 428 and determine an avoided penalty resulting from implementation of the modification. Additionally or alternatively, one of the models 652 may be a utility cost saving model, which the resource consumption calculator 635 may implement to compare utility costs or resources before and after implementation of the modification to determine a resource savings associated with optimized energy usage.

In some embodiments, the models 652 may include one or more asset performance models for the various assets of the building subsystems 428. For example, one of the models 652 may be an asset life savings model, which the resource consumption calculator 635 may implement to determine or predict asset performance metrics and fault occurrences for a building asset before and after implementation of a modification. In some embodiments, the resource consumption calculator 635 may implement the asset life savings model to determine various corrective actions or other modifications that may optimize the lifespan of the building asset. Additionally or alternatively, one of the models 652 may be a maintenance avoidance model, which the resource consumption calculator 635 may implement to compare historical maintenance events or frequency for a building asset before and after implementation of the modification to determine a reduction in maintenance needs and associated resource consumption. Additionally or alternatively, one of the models 652 may be an operational efficiency model, which the resource consumption calculator 635 may implement to compare one or more operational efficiency metrics for the building asset before and after implementation of the modification to determine an operational efficiency improvement. The one or more operational efficiency metrics may include a response time, task completion time, throughput, or equipment utilization for the building asset.

In some embodiments, the models 652 may include one or more time savings models for the various assets of the building subsystems 428. For example, one of the models 652 may be a time savings model, which the resource consumption calculator 635 may implement to track an amount of time spent on one or more manual monitoring, control, diagnostic, or maintenance tasks associated with the building asset before and after implementation of the modification to determine a time savings based on a reduction in the amount of time spent on the one or more tasks. Additionally or alternatively, one or more of the models 652 may be a productivity model, which the resource consumption calculator 635 may implement to measure changes in one or more productivity metrics before and after implementation of the modification to determine a productivity improvement for the building asset. The productivity metrics may be or include a task completion rate, work order completion rate, occupant productivity, staff efficiency, among others. In some embodiments, the models 652 may further include one or more health models for the various assets of the building subsystems 428. For example, one of the models 652 may be an indoor air quality improvement model, which the resource consumption calculator 635 may implement to monitor one or more indoor air quality parameters before and after implementation of the modification and determine an indoor air quality improvement. The indoor air quality improvement model may also be used to determine an associated impact of the indoor air quality improvement on at least one additional metric, such as an occupant health, occupant absenteeism, comfort index level, or occupant productivity level, among others.

As described above, at least one of the models 652 may be used to determine energy waste due to manual interventions. For example, the resource monitoring circuit 630 may determine that an AHU operating in a manual mode has a high energy consumption level. The resource consumption calculator 635 may implement the following model 652 to determine an energy wastage amount as a result of the manual mode:

$${E}_{w} = {\sum }_{i = 1}^{N} ( {P}_{manual} , i - {P}_{b a s e} , i ) \times T i ,$$

where E_{w} is an amount of energy waste, Pₘₐₙᵤₐₗ,i is an actual power usage of the AHU operating in manual mode, and P_{base},i is an expected power usage of the AHU operating in an automated mode. The resource consumption calculator 635 may use the calculated energy waste, E_{w}, to generate a projected resource preservation amount associated with changing the AHU to an automated mode (e.g., fixed room temperature setpoints, etc.). Another one of the models 652 may be used to determine an energy wastage due to manual interventions. For example, a chilled water valve on an AHU may remain open due to a manual override. The resource consumption calculator 635 may implement the following mathematical model to determine the heat transfer rate Q_{c} (W or J/s) of the chilled water valve operating with the manual override: Q_{c}=ρ_{w}V_{w}CₚΔT_{w}, where ρ_{w} (kg/m³) is water density, V_{w} is water flow rate (m³/s), Cₚ is specific heat capacity of water (J/(kg·°C)), and ΔT_{w} is a temperature difference between supplied water and returned water (°C). The resource consumption calculator 635 may use the calculated heat transfer rate Q_{c} to generate a projected resource preservation amount (e.g., energy preservation, thermal energy preservation, etc.) for the AHU associated with automating control of the chilled water valve. Similarly, another one of the models 652 may be used by the resource consumption calculator 635 to determine power loss associated with a pump: Eₚ=ρ_{w}gHV_{wηp}×T, where Eₚ is potential energy (J), ρ_{w} is density of water (kg/m³), g is gravitational acceleration (m/s²), His height or head of water (m), V_{w} is volumetric flow rate of water (m³/s), ηₚ is efficiency of the pump, and T is time(s). The resource consumption calculator 635 may implement this equation to identify potential energy preservation associated with automating control of the pump.

As described above, the models 652 may include mathematical models to identify resource wastage due to equipment inefficiency. For example, the resource consumption calculator 635 may implement an inefficiency metric n to quantify a projected energy wastage trajectory associated with inefficient operation of a building device:

$$Ei = {\sum }_{i = 1}^{N} ( {P}_{actual , j} \times {Δ}_{efficiency , j} \times {T}_{j} ) ,$$

where Δ_{efficiency},j=[(η_{ideal,j}/η_{actual,j})/η_{ideal,j}], P is power (W), and T is time(s). Similarly, the resource consumption calculator 635 may implement a chiller efficiency loss mathematical model to identify energy loss E_{chiller loss} (kWh): E_{chiller loss}=Q_{cooling}×((1/COP_{actual})−(1/COP_{ideal}))×T, where Q is heat transfer (KW), COP is a performance coefficient of the chiller, and T is time(s).

As described above, various other models 652 may be used to determine potential energy preservation amounts associated with reducing an energy supply of a building device. As one example, an energy mathematical model may be represented as Es=P×TEs=P×T, where Es is energy saved (kWh), P is power consumption of the building device (KW), and T is the duration of equipment turned off (hours). As another example, another energy mathematical model may be represented as Er=Pinitial×(1−R)×T, where Er is energy reduced (kWh), P initial is initial power consumption (KW), R is reduction ratio (e.g., percentage reduction in device parameter), and T is duration of reduction (hours). For example, the reduction may include measures such as reduction in fan speed or reduction in valve opening size.

The models 652 may include models to generate a total projected resource preservation trajectory. For example, the resource consumption calculator 635 may implement an overall energy preservation model to determine a total projected resource preservation trajectory associated with automating multiple aspects of a building device. The overall energy preservation model may be Eₜₒₜₐₗ=Es+Er+Ev+Ew+Ei, which may represent a total energy preservation as a summation of direct and indirect energy savings In some embodiments, the resource consumption calculator 635 may implement an expanded version of the overall energy preservation model, which may be

$${E}_{total} = {\sum }_{k = 1}^{X} {P}_{k} {T}_{k} + {\sum }_{l = 1}^{Y} {P}_{initial , l} ( 1 - {R}_{l} ) {T}_{l} + {\sum }_{m = 1}^{Z} ( {P}_{initial , m} - {P}_{new , m} ) {T}_{m} + {\sum }_{i = 1}^{N} {P}_{manual , i} - {P}_{base , i} ) {T}_{i} + {\sum }_{j = 1}^{M} {P}_{actual , j} {Δ}_{efficiency , j} {T}_{j} ,$$

where each of X, Y, Z, N, and M may be different energy preservation strategies utilized by the system 600.

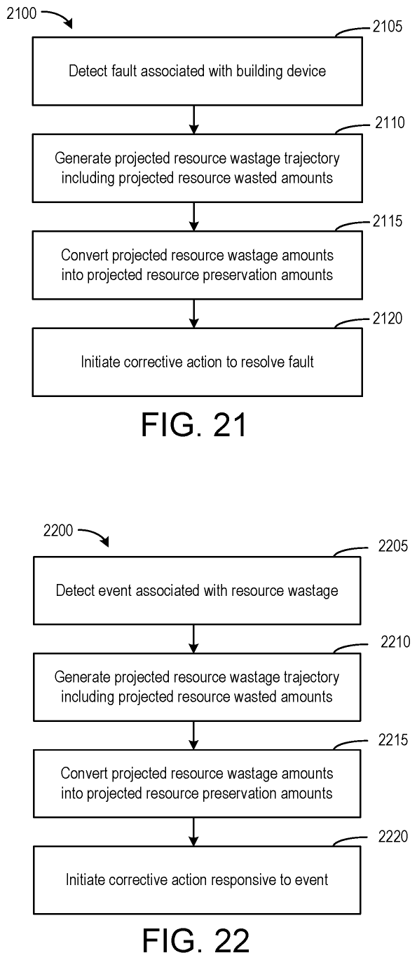

Referring generally to FIGS. 7-20, a plurality of user interfaces are shown and described. The user interfaces may be various interfaces of a single or multiple program or application. Each user interface may be a separate window or may be various portions of a single window or screen. The user interfaces described herein may be related to resource consumption values generated by the system 600 described above. For example, projected resource wastage amounts or project resource preservations amounts may be displayed on one or more of the user interfaces described with respect to FIGS. 7-20. The information provided on the various user interfaces may be generated by the system 600 by one or more processes described further herein. For example, the process of generating the information is described in greater detail with respect to FIGS. 21-23. It is understood that the specific numbers and other text shown on the various user interfaces in FIGS. 7-20 (e.g., resource amounts, costs, dates, ranges, time periods, building names, space names, locations, equipment categories, etc.) may vary based on the specific building(s) for which system 600 is implemented. Additionally, any numbers or other text shown in the various user interfaces in FIGS. 7-20 may be abbreviated or shown with fewer digits in various embodiments.

Referring now to FIG. 7, a user interface (UI) 700 for a dashboard is shown, according to an example embodiment. The user interface 700 may display a summary of resource consumption for a building (e.g., the building 10) or for a building management system comprising a plurality of buildings. For example, the user interface 700 includes one or more widgets 705 to display sustainability key performance indicators (KPIs), such as electrical consumption, energy use intensity, water consumption, water use intensity, thermal consumption, and distinct faults. The KPIs may be reflective of resource consumption over a time period, such as over a calendar year. Therefore, the KPIs will change throughout the time period and be dynamically displayed on the UI 700. The UI 700 also includes asset manager KPIs, such as average building load, total fault cost, distinct faults or occurrences, average fault duration, and total chillers. Similar to the sustainability KPIs, the asset manager KPIs may be displayed via one or more widgets 710. In some embodiments, the UI 700 may be configured such that one of the various widgets 705 and 710 may be selected to view additional information relevant to the respective KPI. The UI 700 may display total resource preservation amounts, including calibrated preservation amounts (e.g., over an entire time period) and realized resource preservation amounts (e.g., resource preservation that has already occurred). The UI 700 may display the resource consumption information with a plurality of widgets including graphs or charts. For example, the UI 700 includes a widget 715 that displays the calibrated preservation amounts and the realized resource preservation amounts corresponding to energy consumption. The UI 700 is also shown to include a widget 720 displaying a graph showing energy consumption over a selected time period (e.g., day, week, one month, three months, six months, one year, etc.) . . . . Additionally, the UI 700 may include a widget 725 including a chart showing equipment fault categories over a selected time period (e.g., day, week, one month, three months, six months, one year, etc.). For example, the categories include comfort, maintenance, energy, cleaning, new fault, and compliance. Each of the widgets 720, 725, and 730 may include one or more selectable elements to allow a user to update the selected time period and/or the resource, which may in turn update the resource consumption data displayed on the corresponding widget. Similar to the widgets 705 and 710, the UI 700 may be configured such that one of the various widgets 715, 720, or 725 may be selected to view additional information relevant to the respective displayed resource consumption data.

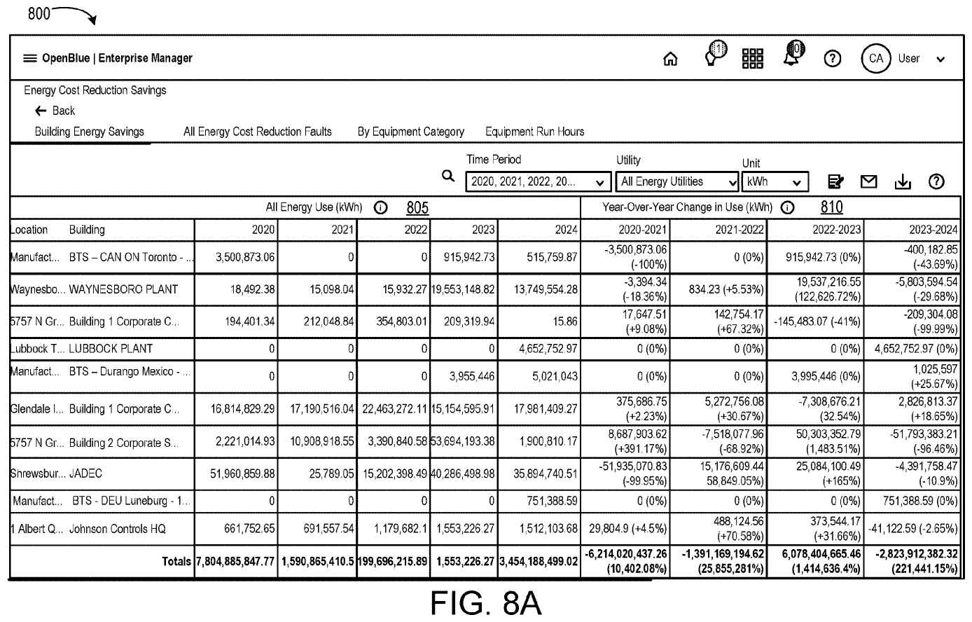

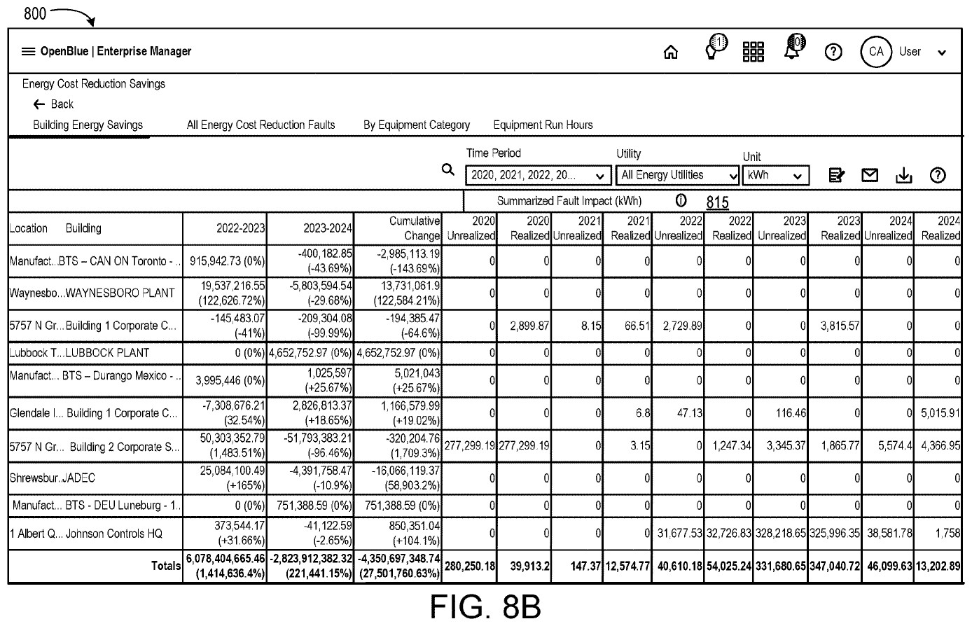

Referring now to FIGS. 8A-8B, a user interface (UI) 800 for a dashboard is shown, according to an example embodiment. The UI 800 may display a list of various buildings within a building management system. For example, the UI 800 displays an overview of energy consumption information for ten buildings. For each building, the UI 800 displays a location (e.g., an address) and building (e.g., building name or identifier), among other identification information. The UI 800 may further display all energy use for each of the buildings over a plurality of time periods (e.g., years). For example, a widget 805 may display, for each building, total energy utility usage in kWh for each year of a selected range of years. Additionally or alternatively, the UI 800 may include a widget 810, which displays a year-to-year change in resource usage for each building, such as an absolute change in energy usage and/or a percentage change in energy usage between consecutive time periods. Additionally or alternatively, the UI 800 may include a widget 815 that displays summarized fault impact information for each building. For example, the widget 815 may display an unrealized impact of resource consumption (e.g., energy consumption) and realized fault impact over one or more time periods, along with a cumulative change associated with the fault impact. The unrealized fault impact may refer to an amount of resource wastage associated with one or more unresolved faults, such as an amount of excess energy consumption resulting from one or more fault remaining uncorrected during the corresponding time period. The realized fault impact may refer to an amount of resource preservation actually achieved in response to resolution of one or more faults during the corresponding time period. As shown, the UI 800 may include one or more selectable elements, which may allow a user interacting with the UI 800 to select between different time periods, utilities, and units. For example, the resource consumption data displayed on the UI 800 is shown to relate to energy consumption (kWh) for a time period of 2020-2024. However, the one or more selectable elements may be manipulated to modify the displayed data to show resource consumption for a different resource and/or for a different time period. Similar to the UI 700, one or more of the widgets 805-815 displayed on the UI 800 may be selectable such that a user can selectively view additional resource consumption and/or fault impact information for a specific building or building asset.

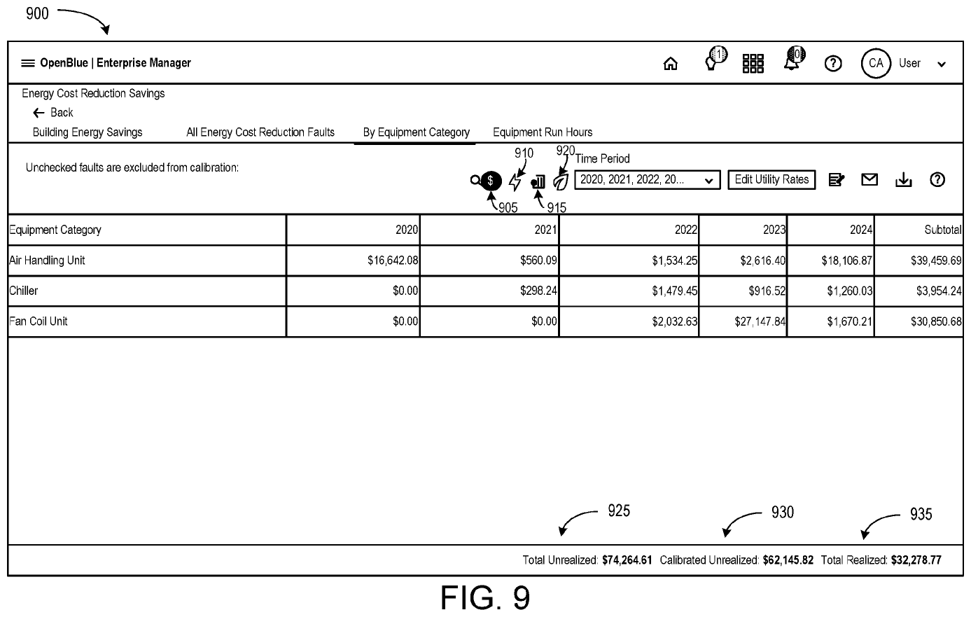

Referring now to FIGS. 9-12, user interfaces 900, 1000, 1100, and 1200 for a dashboard are shown, according to an example embodiment. The dashboard depicted by the UIs 900-1200 may organize the information from the UI 800 by equipment category. For example, the UIs 900-1200 display a list of equipment categories, including air handling units, chillers, and fan coil units. Similar to the UI 800, each of the UIs 900-1200 may include one or more selectable elements, which may allow the user interacting with the UIs to select between different time periods and utility rates, among others. Additionally or alternatively, each of the UIs 900-1200 may include a plurality of selectable widgets or elements associated with various resource types. For example, the selectable widget 905 may symbolize a first resource (e.g., cost, etc.), the selectable widget 910 may symbolize a second resource (e.g., energy, etc.), the selectable widget 915 may symbolize a third resource (e.g., thermal energy, etc.), and the selectable widget 920 may symbolize a fourth resource (e.g., carbon emission, etc.). The selectable widgets 905-920 may be selectively selected to display various resource consumption related information associated with the respective symbolized resource.

As shown in FIG. 9, the UI 900 depicts the dashboard when the selectable widget 905 representing the first resource is selected. Accordingly, the dashboard may display the amount of resource consumption for the first resource during the selected time period. For example, the UI 900 displays the amount of resource consumption corresponding to the first resource based on operating conditions of the air handling units, the chillers, and the fan coil units of the buildings in each year of the selected time period (e.g., 2020, 2021, 2022, 2023, and 2024). As shown, the UI 900 may display a total unrealized preservation amount 925 corresponding to the unrealized preservation amounts for all of the building assets across the equipment categories, and a calibrated unrealized preservation amount 930 corresponding to the unrealized preservation amounts for one or more selected building assets. As described above, the unrealized resource preservation amounts may refer to amounts of the first resource that could have been preserved if one or more identified faults or inefficient operating conditions associated with the building assets were corrected during the corresponding time period. The UI 900 may further display a total realized preservation amount 935 corresponding to the realized preservation amount of the first resource for all of the building assets across the equipment categories.

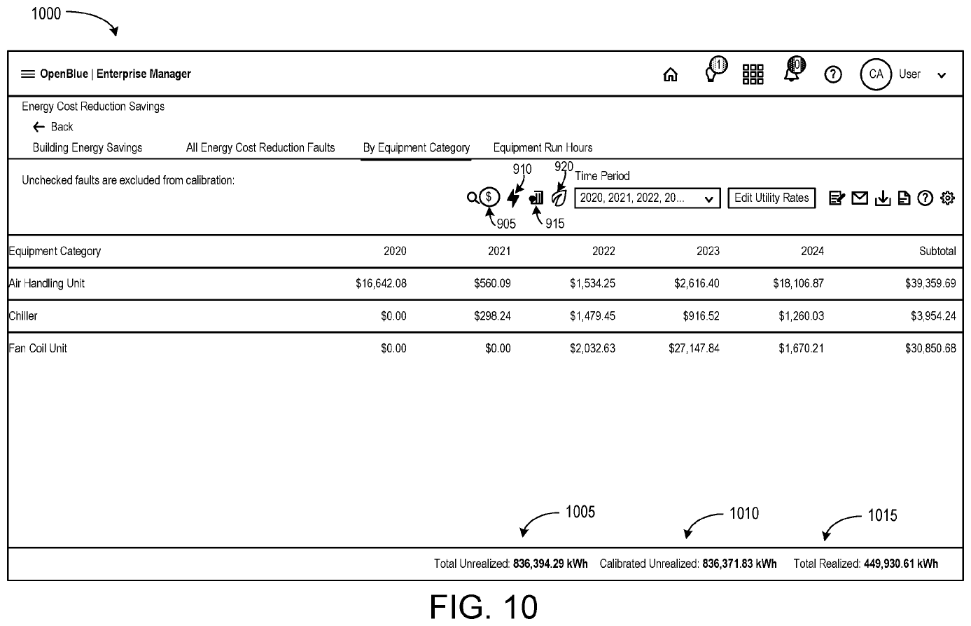

As shown in FIG. 10, the UI 1000 depicts the dashboard when the selectable widget 910 representing the second resource is selected. Accordingly, the dashboard may display the amount of resource consumption for the second resource during the selected time period. For example, the UI 1000 displays the amount of resource consumption corresponding to the second resource based on operating conditions of the air handling units, the chillers, and the fan coil units of the buildings in each year of the selected time period (e.g., 2020, 2021, 2022, 2023, and 2024). As shown, the UI 1000 may display a total unrealized preservation amount 1005 corresponding to the unrealized preservation amounts for all of the building assets across the equipment categories, and a calibrated unrealized preservation amount 1010 corresponding to the unrealized preservation amounts for one or more selected building assets. As described above, the unrealized resource preservation amounts may refer to amounts of the second resource that could have been preserved if one or more identified faults or inefficient operating conditions associated with the building assets were corrected during the corresponding time period. The UI 1000 may further display a total realized preservation amount 1015 corresponding to the realized preservation amount of the second resource for all of the building assets across the equipment categories.

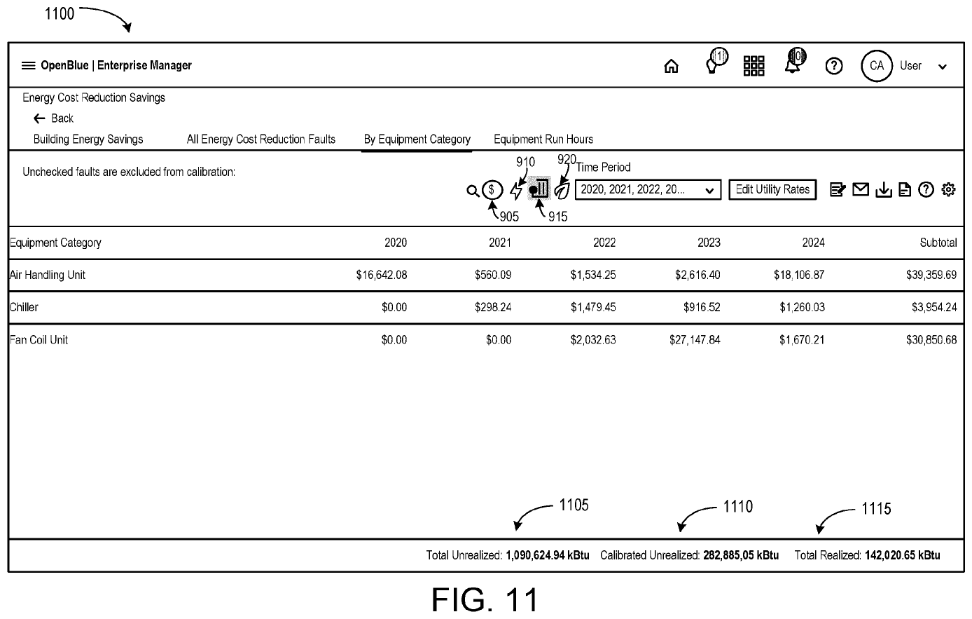

As shown in FIG. 11, the UI 1100 depicts the dashboard when the selectable widget 915 representing the third resource is selected. Accordingly, the dashboard may display the amount of resource consumption for the third resource during the selected time period. For example, the UI 1100 displays the amount of resource consumption corresponding to the third resource based on operating conditions of the air handling units, the chillers, and the fan coil units of the buildings in each year of the selected time period (e.g., 2020, 2021, 2022, 2023, and 2024). As shown, the UI 1100 may display a total unrealized preservation amount 1105 corresponding to the unrealized preservation amounts for all of the building assets across the equipment categories, and a calibrated unrealized preservation amount 1110 corresponding to the unrealized preservation amounts for one or more selected building assets. As described above, the unrealized resource preservation amounts may refer to amounts of the third resource that could have been preserved if one or more identified faults or inefficient operating conditions associated with the building assets were corrected during the corresponding time period. The UI 1100 may further display a total realized preservation amount 1115 corresponding to the realized preservation amount of the third resource for all of the building assets across the equipment categories.

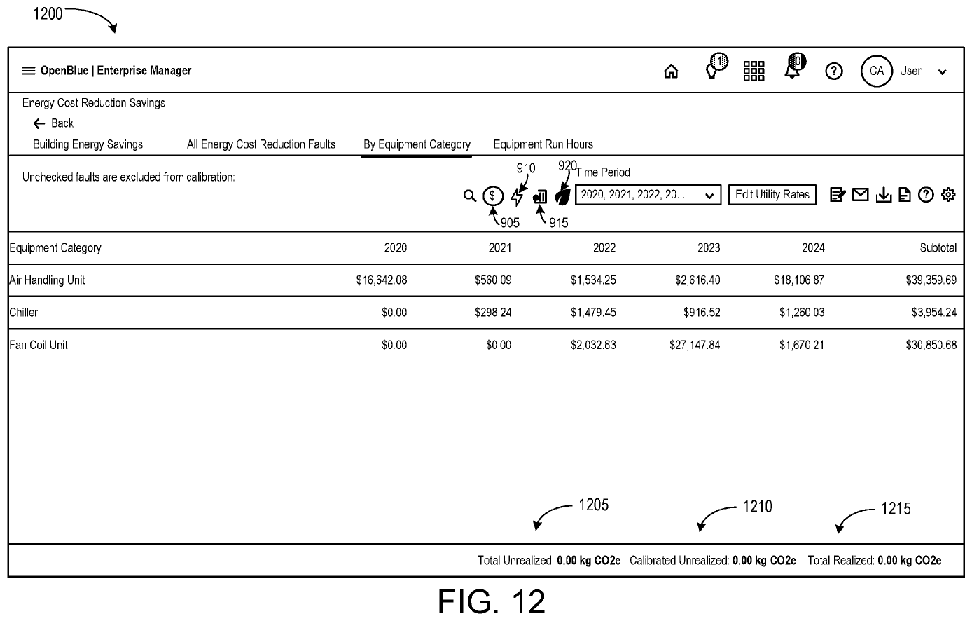

As shown in FIG. 12, the UI 1200 depicts the dashboard when the selectable widget 920 representing the fourth resource is selected. Accordingly, the dashboard may display the amount of resource consumption for the fourth resource during the selected time period. For example, the UI 1200 displays the amount of resource consumption corresponding to the fourth resource based on operating conditions of the air handling units, the chillers, and the fan coil units of the buildings in each year of the selected time period (e.g., 2020, 2021, 2022, 2023, and 2024). As shown, the UI 1200 may display a total unrealized preservation amount 1105 corresponding to the unrealized preservation amounts for all of the building assets across the equipment categories, and a calibrated unrealized preservation amount 1110 corresponding to the unrealized preservation amounts for one or more selected building assets. As described above, the unrealized resource preservation amounts may refer to amounts of the fourth resource that could have been preserved if one or more identified faults or inefficient operating conditions associated with the building assets were corrected during the corresponding time period. The UI 1200 may further display a total realized preservation amount 1215 corresponding to the realized preservation amount of the fourth resource for all of the building assets across the equipment categories.

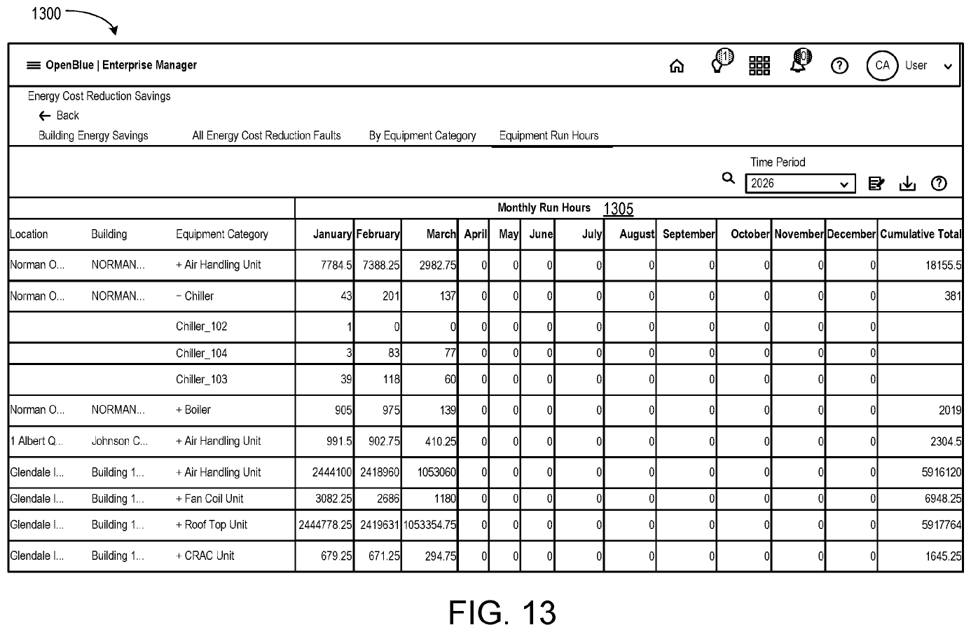

Referring now to FIG. 13, a user interface (UI) 1300 for a dashboard is shown, according to an example embodiment. The UI 1300 may display equipment run hour information for various buildings within the building subsystems 428. For example, the UI 1300 displays a list of buildings, equipment categories, and corresponding run hour data for a selected time period. For each entry, the UI 1300 may display a location (e.g., an address or site identifier), a building name or identifier, and an equipment category associated with one or more building devices. The UI 1300 may display the run hour data for the buildings as part of the element or widget 1305, which may display actual run hours for the one or more building devices over a plurality of subperiods within the selected time period, such as monthly run hours for January through December. Additionally or alternatively, the widget 1305 may display a cumulative total of the actual run hours for each equipment category or building device over the selected time period. In some embodiments, the UI 1300 may permit a user to expand an equipment category to view run hour information for individual assets within the equipment category, such as particular chillers, boilers, air handling units, rooftop units, fan coil units, or CRAC units. In some embodiments, the UI 1300 may display actual historical run hours rather than predicted run hours, thereby facilitating evaluation of how much equipment run time has been accumulated for a building device or category of building devices during the selected time period. In some embodiments, the UI 1300 may permit a user to view predicted run hour information for an individual asset (e.g., to view how operating the asset under a detected fault condition may consume the life expectancy of the asset, etc.).

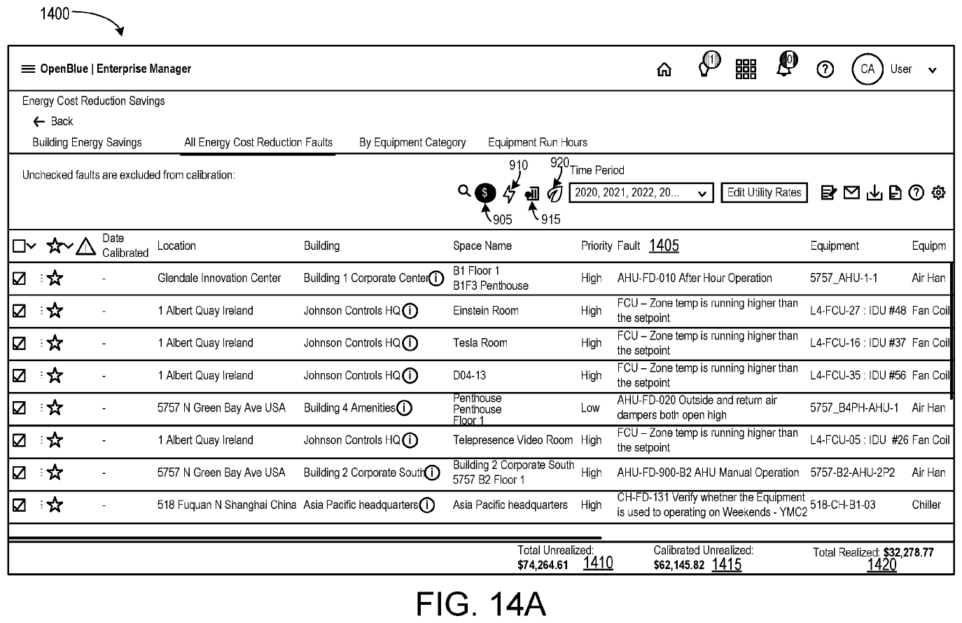

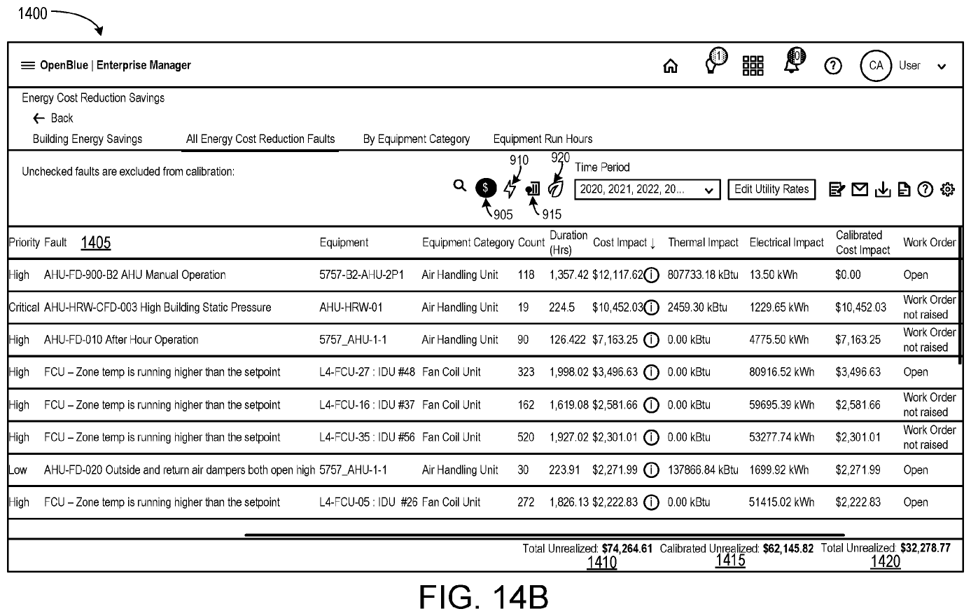

Referring now to FIGS. 14A-17, user interfaces 1400, 1500, 1600, and 1700 for a dashboard are shown, according to an example embodiment. The dashboard depicted by the UIs 1400-1700 may display a list of building devices and/or equipment of the building subsystems 428 and corresponding fault data 1405. The list of faults may correspond to fault conditions detected by the fault detection circuit 625. Each entry of the list may identify an equipment name or identifier, location, building, and space name for the respective building asset. Each entry of the list may further include the corresponding fault data 1405 associated with an identified fault condition for the building asset. The fault data 1405 may identify the fault (e.g., after hour operation, zone temperature running higher than setpoint, etc.). Further, the fault data 1405 may include a priority level for each of the identified faults. For each identified fault, the UI 1400 may display additional data, such as an impact on various resource consumption levels and a work order status, among other information. Additionally, one or more warning widgets may be displayed. The presence of a warning widget may serve to notify the client that the fault or the building device should be further investigated. In some embodiments, a warning widget may be displayed for one of the faults if the projected resource wastage trajectory of the device meets or exceeds a minimum wastage threshold. For example, the minimum wastage threshold may be related to a percentage of total resource consumption that may be preserved by resolving the fault (e.g., 30% of a total resource consumption, 40% of a total resource consumption, etc.).

Similar to the UIs 900-1200, the UIs 1400-1700 may include the plurality of selectable widgets 905-920, such that a user can selectively view corresponding resource consumption or preservation insights associated with the listed faults. On the UI 1400, the first resource is selected via the selectable widget 905. Accordingly, the list of faults or events includes the projected wastage amount of the first resource associated with each device operating with the fault. For example, the UI 1400 may display a total unrealized preservation amount 1410 corresponding to the unrealized preservation amounts for all of the listed building assets, and a calibrated unrealized preservation amount 1415 corresponding to the unrealized preservation amounts for one or more selected building assets (e.g., selected from the list via a plurality of selectable UI elements). The UI 1400 may further display a total realized preservation amount 1420 corresponding to the realized preservation amount of the first resource for all of the listed building assets.

On the UI 1500, the second resource is selected via the selectable widget 910. Accordingly, the list of faults or events includes the projected wastage amount of the second resource associated with each device operating with the fault. For example, the UI 1500 may display a total unrealized preservation amount 1505 corresponding to the unrealized preservation amounts for all of the listed building assets, and a calibrated unrealized preservation amount 1510 corresponding to the unrealized preservation amounts for one or more selected building assets (e.g., selected from the list via a plurality of selectable UI elements). The UI 1500 may further display a total realized preservation amount 1515 corresponding to the realized preservation amount of the second resource for all of the listed building assets. On the UI 1600, the third resource is selected via the selectable widget 915. Accordingly, the list of faults or events includes the projected wastage amount of the third resource associated with each device operating with the fault. For example, the UI 1600 may display a total unrealized preservation amount 1605 corresponding to the unrealized preservation amounts for all of the listed building assets, and a calibrated unrealized preservation amount 1610 corresponding to the unrealized preservation amounts for one or more selected building assets (e.g., selected from the list via a plurality of selectable UI elements). The UI 1600 may further display a total realized preservation amount 1615 corresponding to the realized preservation amount of the third resource for all of the listed building assets. On the UI 1500, the fourth resource is selected via the selectable widget 920. Accordingly, the list of faults or events includes the projected wastage amount of the fourth resource associated with each device operating with the fault. For example, the UI 1700 may display a total unrealized preservation amount 1705 corresponding to the unrealized preservation amounts for all of the listed building assets, and a calibrated unrealized preservation amount 1710 corresponding to the unrealized preservation amounts for one or more selected building assets (e.g., selected from the list via a plurality of selectable UI elements). The UI 1700 may further display a total realized preservation amount 1715 corresponding to the realized preservation amount of the fourth resource for all of the listed building assets.

In some embodiments, the UIs 1400-1700 provide additional selectable widgets to allow the client to customize their potential resource preservation amounts. For example, the widgets may be configured such that the client may select one or more of the faults on the list. As a result, the total, calibrated, and realized potential resource preservation amounts are displayed based on only the selected faults. For instance, the client may want to know the amount of resource preservation if only the faults in one building, such as “1 Albert Quay Ireland” are resolved (e.g., a scheduled maintenance event taking place at only one site). Therefore, the fault items relating to “1 Albert Quay Ireland” may be selected via the widgets. The selected fault items may include the faults for the various listed equipment located at the selected location. Accordingly, the total potential resource preservation amounts, calibrated potential preservation amounts, and total realized preservation amounts, are updated or recalculate to reflect the resource preservation amounts associated only with the building devices in the selected location.

Further, the selectable widgets may be configured such that various time ranges may be selected. For example, the selectable widgets on the UIs 1400-1700 have selected a time range corresponding to the years 2020-2024. Therefore, the fault information displayed, including the resource preservation amounts (e.g., total potential, calibrated potential, and total realized) is calculated relative to the selected years. The selectable widgets may be configured to select a different time range. For example, the selectable widgets may select time ranges such as “Last 30 Days,” “Last 90 Days,” “Last 12 Months,” “Year to Date,” or “Since Inception” (inception or detection date for a fault, etc.), among other ranges. The selectable widgets may additionally be configured to allow the client to select a custom time range.

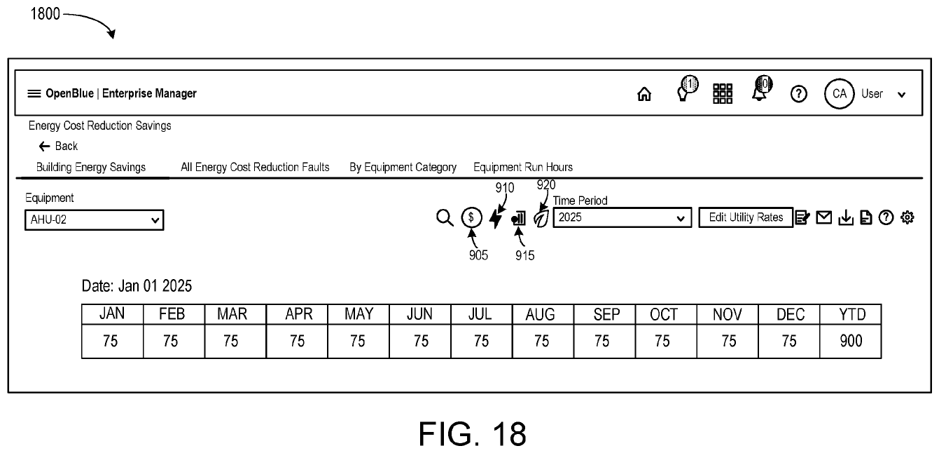

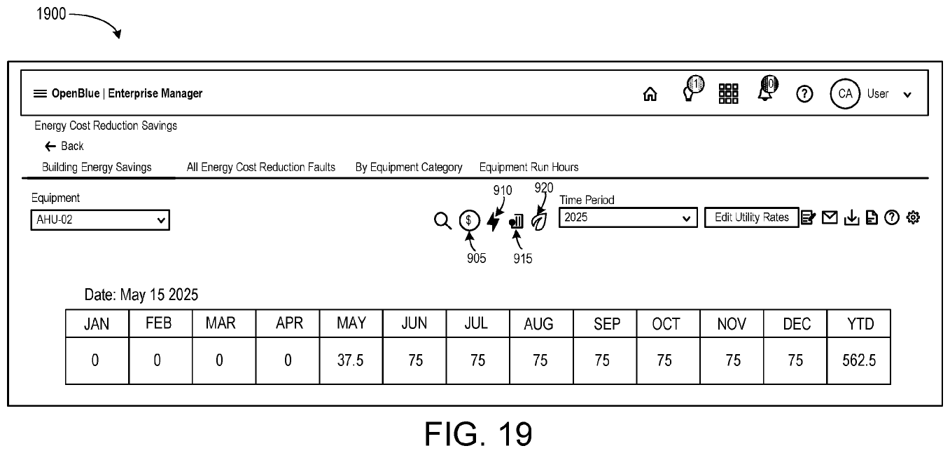

Referring now to FIGS. 18-20, user interfaces 1800, 1900, and 2000 for a dashboard are shown, according to an example embodiment. Each of the faults listed on one of the UIs 1800-2000 may include a selectable widget, such that an individual fault or building device may be selected. For example, FIGS. 19-21 depict UIs for the equipment labeled “AHU-02.” The UIs 1800-2000 may include a selectable widget, such as a dropdown menu, to allow a user interacting with the UIs 1800-2000 to switch between different building devices. Similar to the UIs described above, the UIs 1800-2000 may include the plurality of selectable widgets 905-920 associated with various resource types.

The UIs 1800-2000 depict that the second resource (e.g., widget 910) has been selected by the selectable widgets 905-920. For example, the second resource may relate to energy consumption levels (kWh). The UI 1800 displays the projected resource preservation amount for the time period (e.g., an entire year) that may be realized if the fault is resolved on the current date (e.g., January 1). Additionally, a plurality of preservation amounts for subperiods are displayed (e.g., months). For example, the UI 1800 displays that the building device is projected to preserve 900 kWh of energy over the current year if the fault is resolved on the current date. The UI 1800 also displays that 75 kWh of energy would be preserved each month of the current year.

The UI 1900 depicts the projected resource preservation amount for the time period (e.g., the entire year) that are possible based on a later date. For example, the UI 1900 may be displayed on May 15, and display the projected resource preservation amount for the time period that may be realized if the fault is resolved on the current date (e.g., May 15). For example, the UI 1900 may display that the building device is projected to preserve 562.5 kwH of energy if the fault is resolved on the current date. Additionally, the amount of projected energy consumption preservation during each month of the current year is shown. For example, January, February, March, and April all indicate zero potential resource preservation amounts, since the fault was not resolved during those months. As illustrated, the projected resource preservation amount decreases with time if the fault is not resolved.

In some embodiments, the projected resource preservation amount may be displayed for a selected date. For example, a hypothetical date may be selected (e.g., April 1). The UI 2000 then displayed the projected resource preservation amount that may be realized if the fault is resolved on the selected date (e.g., April 1). The hypothetical selected date may be a future date. For example, the current date may be January 1 and the hypothetical date may be April 1.

FIG. 21 is a flow diagram of a method 2100 for monitoring resource wastage, according to some embodiments. Specifically, the method 2100 relates to monitoring resource wastage associated with building device faults. The system 600 may perform the method 2100. For example, the processor(s) 615 of the system 600 may perform the method 2100. However, it should be understood that any computing system described herein may perform any or all of the operations described in connection with the method 2100.

At step 2105, a fault associated with a building device is detected. For example, the processor(s) 615 may detect a fault associated with a building device occurring at a first time. The building device may be one of a plurality of building devices within the building subsystems 428.

At step 2110, a projected resource wastage trajectory is generated. For example, the building device operating with the fault may consume an increased amount of resources. Therefore, one or more components of the system 600, such as the resource consumption calculator 635, may generate the projected resource wastage trajectory. The projected resource wastage trajectory indicate an amount of resource wastage predicted to occur during a time period as a result of the building device operating with the fault. In some implementations, the resource consumption calculator 635 may predict the amount of resource wastage predicted to occur in one full year (e.g., beginning at the first time). Alternatively, the consumption calculator 635 may predict the amount of resource wastage predicted to occur in a remainder of a current calendar year. The time period may be any other period of time (e.g., 1 month, 6 months, a customized time period, etc.). As an example, an AHU running with a fault may have an asset life of 10,000 hours. The resource consumption calculator 635 may determine that, over the time period (e.g., one year), an additional 3,000 hours of the asset life may be consumed if the AHU continues to operate with the fault.

The projected resource wastage trajectory may include a plurality of projected resource wastage amounts. Each projected resource wastage amounts may correspond to a different subperiod of the time period. For example, each projected resource wastage amount may correspond to one month and the time period may respond to a full, twelve-month year. Each projected resource wastage amount may indicate an amount of resource wastage predicted to occur during the subperiod as a result of the building device operating with the fault. Continuing with the previous AHU example, the resource consumption calculator 635 may determine that, for each month of the year, an additional 250 hours of asset life may be consumed if the AHU continues to operate with the fault.

The resource consumption calculator 635 may implement a plurality of mathematical models (e.g., models 6520 to generate resource wastage trajectories related to energy and sustainability, including energy, greenhouse gas (GHG), regulatory compliance, and utility cost. For example, an energy mathematical model may be implemented. The energy model may compare a baseline energy usage of the building device before the fault occurred to a new energy usage of the building device operating with the fault. The resource consumption calculator 635 may use the difference between the energy usage levels to generate the projected resource wastage trajectory. Similarly, the models 652 may be implemented to generate the projected resource preservation amounts. For example, the energy model may compare a baseline energy usage of the building device while it operated with the fault to a new energy usage of the building device once the fault has been resolved. The resource consumption calculator 635 may use the difference between the energy usage levels to generate the projected resource preservation amount.

In some embodiments, a priority level is generated for the fault based on the projected resource wastage trajectory. For example, the resource consumption calculator 635, or another component of the resource management system 605, may classify the fault based on the amount of resource associated with the resource wastage trajectory. In general, a high resource wastage trajectory indicates that the resource consumption of the building device has increased by a large amount. The priority levels may be generated using threshold resource amount levels. For example, if the amount of resource associated with the projected resource wastage trajectory does not meet a minimum resource amount threshold, the fault may be classified as a low-priority fault. Conversely, if the amount of resource associated with the projected resource wastage trajectory meets or exceeds the minimum resource amount threshold, the fault may be classified as a high-priority fault. In some embodiments, more than one threshold is implemented, and therefore the priority levels may have greater than two classifications (e.g., low priority, moderate priority, high priority, extreme priority, etc.).

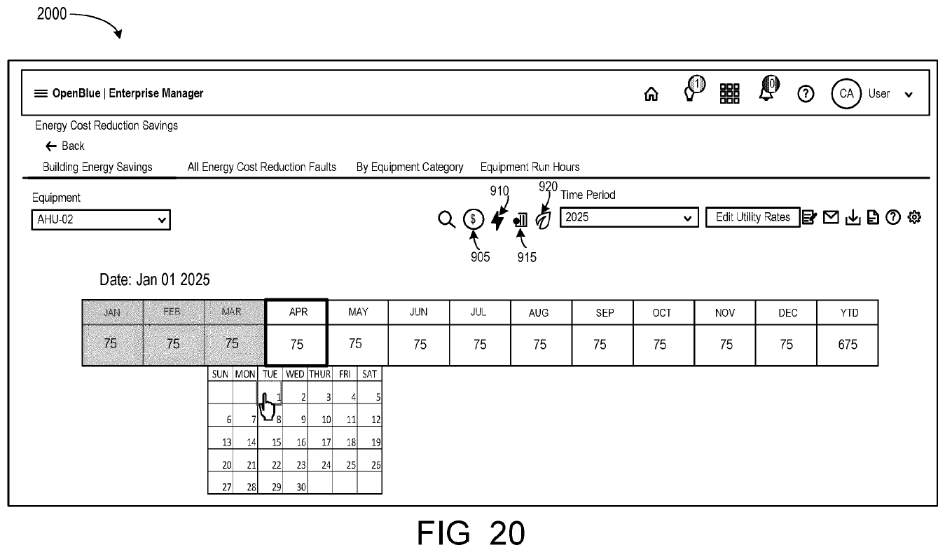

At step 2115, the projected resource wastage amounts are converted into projected resource preservation amounts. For example, the resource consumption calculator 635 may convert the projected resource wastage amounts occurring after a second time during the time period into the projected resource preservation amounts. The second time may be a time at which an identified corrective action may be taken to correct the fault. Therefore, in response to identifying the corrective action to be taken (e.g., by the corrective action circuit 645, etc), the resource consumption calculator 635 may perform the conversion to determine the amount of resource preservation possible if the corrective action is performed at the second time. Essentially, the amount of projected resource wastage amounts associated with the remaining subperiods of the time period may be considered to be preserved. In some embodiments, the resource consumption calculator 635 may generate the projected resource preservation amounts based on a scheduled or hypothetical time to resolve the fault. For example, FIG. 20 shows the projected resource preservation amounts that are projected to be realized if the fault is resolved on a selected future date. In some embodiments, the models 652 may be implemented to convert the wastage amounts to the projected preservation amounts.

At step 2120, the corrective action to resolve the fault is initiated. For example, the corrective action circuit 645 may initiate the identified corrective action at the second time to resolve the fault. The corrective action may include at least one of an equipment setpoint change, a work order creation, an equipment maintenance action, an equipment replacement, or an equipment update (e.g., automatic or manual updates for software, firmware, controls, etc.). Responsive to resolving the fault, the projected resource preservation amounts may be realized. For example, a realized resource preservation amount may be determined for the time period. The realized resource preservation amount may be based on the one or more projected resource preservation amounts for the one or more subperiods occurring after the second time. The realized resource preservation amount may be determined in response to determining that the corrective action was performed or taken at the second time to resolve the fault.

In some embodiments, the resource management system 605 may determine the time at which the fault was resolved. For example, the resource monitoring circuit 630 may determine that the fault was resolved at the second time. For example, the resource monitoring circuit 630 may make the determination based on operating data characterizing operation of the building device after the second time. Therefore, the resource consumption values generated by the resource management system 605 may maintain accuracy even if a corrective action was manually performed without documentation.

FIG. 22 is a flow diagram of a method 2200 for monitoring resource wastage, according to some embodiments. Specifically, the method 2200 relates to monitoring resource wastage associated with various building events. The system 600 may perform the method 2200. For example, the processor(s) 615 of the system 600 may perform the method 2200. However, it should be understood that any computing system described herein may perform any or all of the operations described in connection with the method 2200.

At step 2205, an event is detected. Specifically, an event associated with resource wastage is detected. The event may be a fault associated with a building device occurring at a first time, which may be detected by the fault detection circuit 625. Additionally or alternatively, the event may be detected by the resource monitoring circuit 630. For example, the resource monitoring circuit 630 may detect events such as a building device operating when its operation is not required (e.g., a thermostat running at full capacity when the building is unoccupied, a heater running when the building does not need to be heated, etc.), the building device operating with unnecessary manual intervention, and inefficient equipment performance, among others.

At step 2210, a projected resource wastage trajectory is generated. The projected resource wastage trajectory may indicate an amount of resource wastage predicted to occur during a time period as a result of the building device operating under the conditions associated with the event. For example, the resource consumption calculator 635 may predict the amount of resource wastage predicted to occur in one full year (e.g., beginning at the first time). As another example, the consumption calculator 635 may predict the amount of resource wastage predicted to occur in a remainder of a current calendar year.

At step 2215, the projected resource wastage amounts are converted into projected resource preservation amounts. For example, the resource consumption calculator 635 may convert the projected resource wastage amounts occurring after a second time during the time period into the projected resource preservation amounts. The second time may be a time at which an identified corrective action may be taken to adjust the conditions of the building device operation. Therefore, in response to identifying the corrective action to be taken (e.g., by the corrective action circuit 645, etc.), the resource consumption calculator 635 may perform the conversion to determine the amount of resource preservation possible if the corrective action is performed at the second time. In some embodiments, the resource consumption calculator 635 may generate the projected resource preservation amounts based on a scheduled or hypothetical time to take the corrective action. In some embodiments, the models 652 may be implemented to convert the wastage amounts to the projected preservation amounts.

At step 2220, the corrective is initiated responsive to the event. For example, the corrective action circuit 645 may initiate the identified corrective action at the second time to adjust the conditions of the building device operation. The corrective action may include at least one of a dynamic control (e.g., turning off the building device when its operation is not required, etc.), an equipment update (e.g., to minimize manual interventions and therefore reduce the energy wastage associated with manual interventions), among other actions that may be identified to improve the resource consumption of the building device. In some other embodiments (e.g., when the event is associated with a fault), the corrective action may include at least one of an equipment setpoint change, a word order creation, an equipment maintenance action, an equipment replacement, or an equipment update. Responsive to performing the corrective action, the projected resource preservation amounts may be realized.

Other corrective actions related to dynamic control include turning off chillers, AHUs, fans, lighting, pumps, cooling towers, and other mapped building systems when not required. Additionally, unnecessary energy supplies may be closed, including chilled water valves, hot water valves, condenser water valves, mixing/bypass valves, and reducing VSD to zero. Additionally, energy supply may be reduced when full operation is not necessary. This may be achieved through measures such as static pressure resets, temperature setpoint resets, discharge air setpoint resets, and driving VAV boxes to minimum positions, among other measures.

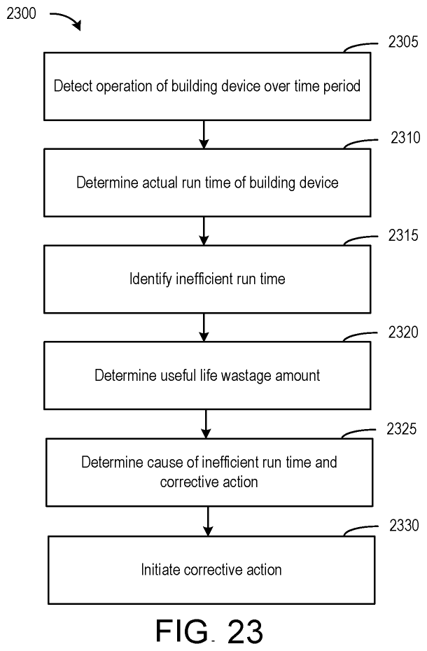

FIG. 23 is a flow diagram of a method 2300 for monitoring resource wastage, according to some embodiments. Specifically, the method 2300 relates to monitoring resource wastage associated with various building events. The system 600 may perform the method 2300. For example, the processor(s) 615 of the system 600 may perform the method 2300. However, it should be understood that any computing system described herein may perform any or all of the operations described in connection with the method 2300.

At step 2305, operation of a building device over a time period is detected. For example, the processor(s) 615 may detect operation of a building device (e.g., a piece of building equipment or building asset of the building subsystems 428) over the time period based on sensor data, status data, control signals, setpoints, alarms, meter data, or other operational data received from the building subsystems 428. The building device may be one of a plurality of building devices within the building subsystems 428, such as an AHU, rooftop unit, chiller, boiler, pump, fan, thermostat, zone controller, or other HVAC, lighting, security, or water system device described herein. In some embodiments, the detected operation may correspond to on/off states, commanded states, actual operating states, or other indicators showing that the building device was operating during the time period.

At step 2310, an actual run time of the building device is determined. For example, the resource monitoring circuit 630 may determine the actual run time for the building device during the time period based on the detected operation. In some embodiments, the actual run time may be determined by aggregating time intervals during which the building device was operating. For example, the resource monitoring circuit 630 may determine that an AHU operated for a total of 3,000 hours during a selected year, or for a total of 250 hours during a selected month. The time period may be a day, a week, a month, a quarter, a year, a remainder of a current calendar year, or another selected time period. In some embodiments, the resource monitoring circuit 630 may store and log the actual log time in the database 650 for subsequent analysis, trend generation, comparison across time periods, or comparison across multiple building devices.

At step 2315, an inefficient run time is identified. For example, the resource monitoring circuit 630 may identify a subset of the actual run time as inefficient run time based on one or more operating conditions associated with the building device during the time period. The inefficient run time may refer to run time during which operation of the building device was unnecessary, avoidable, excessive, or otherwise suboptimal. In some embodiments, the resource monitoring circuit 630 may identify the inefficient run time based on one or more operating conditions indicating that the building device was operating outside of a scheduled period, during an unoccupied period, without a call for operation, without sufficient load or demand, with a fault condition, or in a manner inconsistent with an expected control sequence. For example, the resource monitoring circuit 630 may determine that, out of 3,000 total run hours of an AHU over the selected year, 600 hours occurred during nights, weekends, holidays, or other periods during which the AHU was scheduled to be off or was otherwise not needed. The 600 hours may therefore be identified as inefficient run time. Additionally or alternatively, the resource monitoring circuit 630 may identify an amount of the total run hours as inefficient run time based on the operation of one or more other building assets. For example, the resource monitoring circuit 630 may determine that operation of the building device (e.g., an AHU) was inefficient if the thermostats or zone controllers indicate that no zones were calling for heating or cooling, if occupancy sensors indicate that the served spaces were unoccupied, if the VAV boxes indicate minimal or no airflow demand, or if another asset indicates that sufficient conditioning was already being provided. Accordingly, a portion of the run time of the first building device occurring while the one or more other building assets indicate no need for operation may be identified as inefficient run time.

At step 2320, a useful life wastage amount is determined. For example, the resource consumption calculator 635 may determine the useful life wastage amount indicating an amount of asset life of the building device consumed as a result of the inefficient run time. In some embodiments, the useful life wastage amount may indicate an amount of expected capacity run hours, expected useful life, or another asset life metric consumed by the inefficient run time. For example, if the building device has an expected service life of 10,000 run hours, the resource consumption calculator 635 may determine that the 600 hours of inefficient run time consumed 600 hours, or approximately six percent, of the expected service life of the building device. In some embodiments, the useful life wastage amount may be expressed as run hours consumed, a percentage of expected life consumed, an accelerated degradation amount, a maintenance burden amount, or an associated resource consumption amount (e.g., energy, CO2e emission, etc.). In some embodiments, the resource consumption calculator 635 may determine an amount of actual run hours obtained from the building device relative to the expected capacity run hours for the building device, thereby facilitating evaluation of how much of the expected capacity run hours has been consumed and how much useful life remains. Additionally or alternatively, the resource consumption calculator 635 may determine how much of the expected useful life of the building device was burned up due to after-hours operation, unnecessary operation, or other inefficient operation.

At step 2325, a cause of the inefficient run time and a corrective action is determined. For example, the fault detection circuit 625 or the corrective action circuit 645 may determine the cause of the inefficient run time based on the one or more operating conditions of the building device. The corrective action circuit 645 may determine or identify the corrective action responsive to the identified cause. The corrective action may include at least one of modifying a schedule, changing a setpoint, changing a control sequence, disabling or limiting after-hours operation, reducing operation during unoccupied periods, updating automation logic, resolving a fault condition, generating a work order, dispatching service personnel, or providing a recommendation to a user interface for approval by an operator. For example, if the cause of the inefficient run time is determined to be a schedule mismatch, the corrective action circuit 645 may determine that the corrective action is to update an occupancy schedule. As another example, if the cause of the inefficient run time is determined to be a stuck damper, an overridden control point, or a failed sensor causing unnecessary operation, the corrective action circuit 645 may determine that the corrective action is to generate a maintenance work order or automatically adjust the relevant control parameter. In some embodiments, the corrective action may be selected based at least in part on an amount of useful life wastage associated with the inefficient run time, such that building devices associated with higher levels of wasted run hours or higher percentages of expected life consumed may be prioritized for corrective action.

At step 2330, the corrective action is initiated. For example, the corrective action circuit 645 may initiate the corrective action to modify the operation of the building device. In some embodiments, the corrective action circuit 645 may automatically initiate the corrective action by transmitting one or more control commands to the building subsystems 428 to change a schedule, adjust a setpoint, reset a control parameter, or otherwise modify operation of the building device to reduce inefficient run time. Additionally or alternatively, the corrective action circuit 645 may cause presentation of the cause of the inefficient run time, the useful life wastage amount, and a recommended corrective action via a user interface (e.g., user interface 660), and may initiate the corrective action in response to user input approving the recommended corrective action. In some embodiments, initiation of the corrective action may reduce subsequent inefficient run time, preserve expected capacity run hours of the building device, reduce maintenance burden, and extend the useful life of the building device. In some embodiments, the system 600 may continue to monitor the building device after initiation of the corrective action to determine whether actual run hours, inefficient run hours, or useful life wastage associated with the building device have decreased.

In some implementations, the interface generator 640 may generate, for display on the user interface 660, a GUI identifying the run time data for the building device. For example, the interface generator 640 may generate a dashboard that identifies the actual run time, inefficient run time, after-hours run time, unnecessary run time, or useful life wastage for the building device. In some embodiments, the dashboard may additionally or alternatively identify corresponding run time data for a plurality of building devices within the building subsystems 428, thereby facilitating comparison of actual run hours, inefficient run hours, or life consumption across multiple assets. The dashboard may further indicate expected capacity run hours, expected service life, an amount of expected life already consumed, an amount of expected life remaining, and/or how much useful life was burned up due to inefficient operation of the building device. In some embodiments, the dashboard may present one or more recommended corrective actions, priority indicators, historical trends, or logs indicating when and why inefficient run time occurred.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
detecting, by processing circuitry, a fault associated with a building device occurring at a first time;
generating, by the processing circuitry, a projected resource wastage trajectory comprising a plurality of projected resource wastage amounts, each projected resource wastage amount corresponding to a different subperiod of a time period occurring after the first time and indicating an amount of resource wastage predicted to occur during the subperiod as a result of the building device operating with the fault;
converting, by the processing circuitry, one or more of the plurality of projected resource wastage amounts occurring after a second time during the time period into one or more projected resource preservation amounts in response to identifying a corrective action to be taken at the second time to resolve the fault; and
initiating the corrective action at the second time to resolve the fault and realize the one or more projected resource preservation amounts.

2. The method of claim 1, further comprising determining, by the processing circuitry, a realized resource preservation amount for the time period based on the one or more projected resource preservation amounts for the one or more subperiods occurring after the second time in response to determining that the corrective action was taken at the second time to resolve the fault.

3. The method of claim 1, further comprising determining, by the processing circuitry, that the fault was resolved at the second time based on operating data characterizing operation of the building device after the second time.

4. The method of claim 1, wherein determining the resource wastage trajectory comprises implementing, by the processing circuitry, one or more mathematical models based on at least one of a fault type, an equipment type, or a resource type.

5. The method of claim 4, wherein the one or more mathematical models are modeled based on historical resource consumption data for the building device stored in a database.

6. The method of claim 1, wherein a resource represented by the resource wastage trajectory comprises at least one of energy, greenhouse gas, regulatory compliance, asset life, maintenance needs, operational efficiency metrics, time savings, productivity metrics, or health parameters.

7. The method of claim 1, further comprising generating, by the processing circuitry, a priority level for the fault based on the projected resource wastage trajectory.

8. The method of claim 1, wherein the corrective action comprises at least one of an equipment setpoint change, a work order creation, an equipment maintenance action, an equipment replacement, or an equipment update.

9. A building management system comprising:
one or more processing circuits configured to:
detect a fault associated with a building device occurring at a first time;
generate a projected resource wastage trajectory comprising a plurality of projected resource wastage amounts, each projected resource wastage amount corresponding to a different subperiod of a time period occurring after the first time and indicating an amount of resource wastage predicted to occur during the subperiod as a result of the building device operating with the fault;
convert one or more of the plurality of projected wastage amounts occurring after a second time during the time period into one or more projected resource preservation amounts in response to identifying a corrective action to be taken at the second time to resolve the fault; and
generate, for display on a graphical user interface (GUI), a first display comprising:
a first plurality of widgets including data characterizing a plurality of building devices, at least one widget of the first plurality of widgets corresponding to the building device associated with the fault; and
a second plurality of widgets including at least one of the projected resource wastage trajectory or the plurality of projected resource wastage amounts, or the one or more projected resource preservation amounts.

10. The building management system of claim 9, wherein the one or more processing circuits are further configured to generate, for display on the GUI, a recommendation to initiate the corrective action at the second time to resolve the fault and to realize the one or more projected resource preservation amounts.

11. The building management system of claim 10, wherein the one or more processing circuits are further configured to automatically initiate the corrective action at the second time responsive to receiving an input via the GUI.

12. The building management system of claim 9, wherein the one or more processing circuits are further configured to determine a realized resource preservation amount for the time period based on the one or more projected resource preservation amounts for the one or more subperiods occurring after the second time in response to determining that the corrective action was taken at the second time to resolve the fault.

13. The building management system of claim 9, wherein the one or more processing circuits are further configured to determine that the fault was resolved at the second time based on operating data characterizing operation of the building device after the second time.

14. The building management system of claim 9, wherein determining the resource wastage trajectory comprises implementing one or more mathematical models based on at least one of a fault type, an equipment type, or a resource type.

15. The building management system of claim 14, wherein the one or more mathematical models are modeled based on historical resource consumption data for the building equipment stored in a database.

16. The building management system of claim 9, wherein a resource represented by the resource wastage trajectory comprises at least one of energy, greenhouse gas, regulatory compliance, asset life, maintenance needs, operational efficiency metrics, time savings, productivity metrics, or health parameters.

17. The building management system of claim 9, wherein the one or more processing circuits are further configured to generate a priority level for the fault based on the projected resource wastage trajectory.

18. The building management system of claim 9, wherein the corrective action comprises at least one of an equipment setpoint change, a work order creation, an equipment maintenance action, an equipment replacement, or an equipment update.

19. A non-transitory computer readable medium including one or more instructions stored thereon and executable by a processor to:
detect operation of a building device over a time period;
determine an actual run time of the building device during the time period based on the detected operation;
identify a subset of the actual run time as inefficient run time based on one or more operating conditions associated with the building device during the time period;
determine a useful life wastage amount indicating an amount of asset life of the building device consumed as a result of the inefficient run time;
determine, based on the one or more operating conditions, a cause of the inefficient run time and a corrective action responsive to the cause; and
initiate the corrective action to modify the operation of the building device.

20. The non-transitory computer readable medium of claim 19, the non-transitory computer readable medium further including one or more instructions executable by the processor to:
generate, for display on a graphical user interface (GUI), a display comprising:
a first plurality of widgets including data characterizing a plurality of building devices, at least one widget of the first plurality of widgets corresponding to the building device associated with the inefficient run time; and
a second plurality of widgets including at least one of the actual run time of the building device, the inefficient run time, or the useful life wastage amount.
